(19) United States
(12) Patent Application Publication
(10) Pub. No.: US 2020/0229514 A1
(43) Pub. Date: Jul. 23, 2020

(54) SMART SENSING APPAREL

(71) Applicant: THE NORTH FACE APPAREL CORP., Wilmington, DE (US)

(72) Inventors: Benjamin Cooper, Dover, NH (US); Tadd Nicholas Smith, Rye, NH (US)

(21) Appl. No.: 16/306,377

(22) PCT Filed: Jun. 2, 2017
(86) PCT No.: PCT/US2017/035602

§ 371 Date: Nov. 30, 2018

Related U.S. Application Data
(60) Provisional application No. 62/344,636, filed on Jun. 2, 2016.
(60) Provisional application No. 62/344,656, filed on Jun. 2, 2016.
(60) Provisional application No. 62/344,643, filed on Jun. 2, 2016.

(51) Int. Cl. A41D 1/00; H04B 1/3827; G01W 1/02

(52) U.S. Cl. CPC A41D 1/002; G01W 1/02; H04B 1/385

(57) ABSTRACT

System and methods for managing comfort of a wearer of apparel are disclosed. One method includes determining a first environmental characteristic using a first sensor disposed adjacent an item of apparel; determining a second environmental characteristic using a second sensor disposed adjacent the item of apparel; determining a comfort signature based at least on the first environmental characteristic and the second environmental characteristic; and providing a response to a wearer of the item of apparel based at least upon the comfort signature.

### TECHNICAL FIELD

This patent disclosure relates generally to sensing technology for apparel and more particularly to methods and systems for sensing various characteristics relating to apparel and wearers of the same.

### BACKGROUND

Apparel is often worn to offer protection for the wearer and to provide insulation for warming a wearer's body. Wearers may select particular apparel based upon environmental conditionals, such as, temperature, wind, and precipitation. Often, apparel is personal to the wearer and may signal and express aspects of the wearer such as mood, hobbies, status, etc. As such, wearers adorn different kinds of clothes and shoes, such as, casual, formal, fashionable, underwear, outerwear, etc.

Recent developments in apparel include smart clothing. Smart clothing or digital clothing describes combining clothing with information technology. This includes the incorporation of digital devices as part of the clothing. The digital devices may be contained in the clothing, or attachable to the clothing. However, improvements in smart clothing are needed.

### SUMMARY

This patent disclosure relates to system and methods for sensing various characteristics relating to apparel and wearers of the same. Such characteristics may include temperature and humidity and may be sensed as a measurement internal to the apparel, external to the apparel, and/or measurements relating to third-parties separate from the subject apparel or wearer. The sensed characteristics may be processed to generate a heat index. The sensed characteristics may be processed to generate a comfort signature that may be personalized to a particular wearer. As such, the sensed characteristics and/or information generated from the same may be leveraged to provide feedback to a wearer relating to the apparel. Such feedback may include the selective actuation of one or more thermal management elements.

In another aspect, a system may include a memory comprising one or more comfort rules and processor executable instructions; a processor in communication with the memory, the processor configured to: receive a first environmental characteristic associated with a first sensor disposed adjacent an item of apparel; receive a second environmental characteristic associated with a second sensor disposed adjacent the item of apparel; determine a comfort signature based at least on the first environmental characteristic, the second environmental characteristic, and the one or more comfort rules; and provide a response to a wearer of the item of apparel based at least upon the comfort signature.

In yet another aspect, a method may include determining a first environmental characteristic using a first sensor disposed adjacent an item of apparel; determining a second environmental characteristic using a second sensor disposed adjacent the item of apparel; determining a comfort signature based at least on the first environmental characteristic and the second environmental characteristic; and providing a response to a wearer of the item of apparel based at least upon the comfort signature.

In an aspect, a method may comprise: determining a first environmental characteristic using a first sensor disposed adjacent an item of apparel; determining a second environmental characteristic using a second sensor disposed adjacent the item of apparel; determining a comfort signature based at least on the first environmental characteristic and the second environmental characteristic; and causing actuation of a thermal management element based at least on the comfort signature.

In another aspect, a system may include a memory comprising one or more comfort rules and processor executable instructions; a processor in communication with the memory, the processor configured to: receive a first environmental characteristic associated with a first sensor disposed adjacent an item of apparel; receive a second environmental characteristic associated with a second sensor disposed adjacent the item of apparel; determine a comfort signature based at least on the first environmental characteristic, the second environmental characteristic, and the one or more comfort rules; and cause actuation of a thermal management element based at least on the comfort signature.

In one aspect, a method for managing a wardrobe of a wearer may include: receiving or accessing wardrobe information associated with one or more items of apparel available for a user to wear; determining an environmental characteristic relating to an environment where the user intends to wear the one or more items of apparel; determining an activity level relating to wearing the one or more items of apparel; determining a select item of the apparel from the one or more items of apparel based at least on the environmental characteristic and the activity level; and providing a response to the user indicating the select item of apparel from the one or more items of apparel.

In another aspect, a system may include a memory comprising one or more wardrobe rules and processor executable instructions; a processor in communication with the memory, the processor configured to: receive or access wardrobe information associated with one or more items of apparel available for a user to wear; determine an environmental characteristic relating to an environment where the user intends to wear the one or more items of apparel; determine an activity level relating to wearing the one or more items of apparel; determine a select item of the apparel from the one or more items of apparel based at least on the environmental characteristic and the activity level; and provide a response to the user indicating the select item of apparel from the one or more items of apparel.

In yet another aspect, a method may include: receiving or accessing wardrobe information associated with one or more items of apparel available for a user to wear; determining an environmental characteristic relating to an environment where the user intends to wear the one or more items of apparel; determining a comfort signature associated with the user; determining a select item of the apparel from the one or more items of apparel based at least on the environmental characteristic and the activity level; and providing a response to the user indicating the select item of apparel from the one or more items of apparel.

### BRIEF DESCRIPTION OF THE DRAWINGS

FIG. 1 is a block diagram of an example system and network in accordance with aspects of the disclosure.

FIG. 2 is a block diagram of an example system and network in accordance with aspects of the disclosure.

FIG. 3 is a block diagram of an example system and network in accordance with aspects of the disclosure.

FIG. 4 is a block diagram of an example system and network in accordance with aspects of the disclosure.

FIG. 5 is a flow chart of an example method in accordance with aspects of the disclosure.

FIG. 6 is a flow chart of an example method in accordance with aspects of the disclosure.

FIG. 7 is a flow chart of an example method in accordance with aspects of the disclosure.

FIG. 8 is a block diagram of a computer system in accordance with aspects of the disclosure.

FIGS. 9-13 are screen shots of an example user interface in accordance with aspects of the disclosure.

### DETAILED DESCRIPTION

In accordance with aspects of the disclosure, systems and methods provide a tool for determining characteristics of a wearer of apparel. As an example, one or more items of clothing may include a sensor configured to measure temperature and/or humidity. Such information may be transmitted to a computing device for additional processing. In certain aspects, the sensor may communicate measured information to a user device such as a mobile device. As such, the user device may be configured to process the measured data and/or to transmit the measured data over a network or communication path for processing. However, various configurations of sensors, computing devices, and communication mechanisms may be used, as described in further detail below.

The term “apparel” may be defined as one or more article of clothing and may include outerwear, underwear, upper body wear, lower body wear, hats, gloves, footwear, and the like. The term “clothing” may be used to reference apparel and is not limiting to particular garments, headgear, gloves, footwear, or the like.

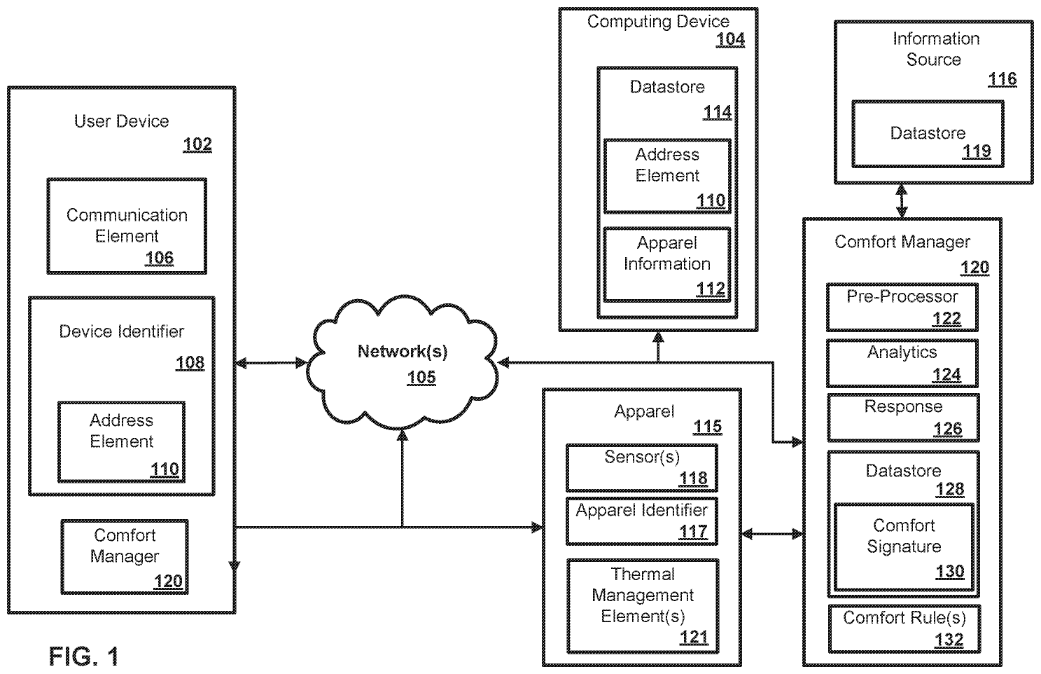

FIG. 1 illustrates various aspects of an exemplary network in which the present methods and systems may operate. Those skilled in the art will appreciate that present methods may be used in various types of networks and systems that employ both digital and analog equipment. The system is described as comprised of elements. An element may be software, hardware, or a combination of software and hardware. One skilled in the art will appreciate that provided herein is a functional description and that the respective functions may be performed by software, hardware, or a combination of software and hardware.

The system and network may include a user device 102 (e.g., physical computer host, virtual machine, IP-capable device) in communication with a computing device 104 such as a server or Network Interface Device (NID), for example. The computing device 104 may be disposed locally, or remotely, relative to the user device 102. As an example, the user device 102 and the computing device 104 may be in communication via a private and/or public network 105 such as the Internet. Other forms of communications may be used such as wired and wireless telecommunication channels, for example.

In an aspect, the user device 102 may be an electronic device such as a computer, a mobile device, a smartphone, a laptop, a tablet, a display device, or other device capable of communicating with the computing device 104. The user device 102 may be configured to communicate information relating to one or more items of clothing (apparel) and/or wearers of the same. The user device 102 may be configured to determine and communicate information relating to another device such as a sensor 118 disposed in or adjacent the apparel.

For example, the user device 102 may be or comprise a mobile computing device such as a smart phone, handheld device, or tablet. The user device 102 may be operatively coupled to one or more networks such as an IP network, a cellular network, near-field network, Bluetooth, ZigBee, or other network specification or protocol. The user device 102 may communicate with the sensor 118 to send and receive signals. In certain aspects, the user device 102 is configured to receive information from the sensor relating to one or more measured characteristics such as environmental characteristics. Such environmental characteristics may include temperature, humidity, pressure, and the like. The user device 102 may be configured to communicate with other devices such as the computing device 104. The user device 102 may receive information from the sensor 118 and may transmit the information to the computing device 104.

The user device 102 may include a communication element 106 for providing an interface to a user to interact with the user device 102 and/or the computing device 104. The communication element 106 may be any interface for presenting information to the user and receiving user feedback, such as a web browser (e.g., Internet Explorer, Mozilla Firefox, Google Chrome, Safari, or the like) or proprietary software, for example. Other software, hardware, and/or interfaces may be used to provide communication between the user and one or more of the user device 102 and the computing device 104. As an example, the communication element 106 may request or query various files from a local source and/or a remote source. As a further example, the communication element 106 may transmit data to a local or remote device such as the computing device 104.

In an aspect, the user device 102 may be associated with a user identifier or device identifier 108. As an example, the device identifier 108 may be any identifier, token, character, string, or the like, for differentiating one user or user device (e.g., user device 102) from another user or user device. In a further aspect, the device identifier 108 may identify a user or user device as belonging to a particular class of users or user devices. As a further example, the device identifier 108 may include information relating to the user device, such as a manufacturer, a model or type of device, a service provider associated with the user device 102, a state of the user device 102, a locator, and/or a label or classifier. Other information may be represented by the device identifier 108. The device identifier 108 may be used for authentication of a user/user device to manage access to particular services or information.

In an aspect, the device identifier 108 may include an address element 110 such as an internet protocol address, a network address, an Internet address, or the like. As an example, the address element 110 may be relied upon to establish a communication session between the user device 102 and the computing device 104 or other devices and/or networks. As a further example, the address element 110 may be used as an identifier or locator of the user device 102.

In an aspect, the computing device 104 may be a server for communicating with the user device 102, other computing devices 104, and/or physical or logical components including, for example, sensors (e.g., sensor 118). As an example, the computing device 104 may communicate with the user device 102 for providing services such as peer-to-peer communication and comfort management services. In an aspect, the computing device 104 may allow the user device 102 to interact with remote resources, such as data, devices, files, and computing elements associated with one or more users or items of apparel 115. As an example, the computing device may be configured as computing module for a particular item of apparel 115. As such, the user device 102 may interact with the computing device 104 to control functions relating to the apparel 115.

In an aspect, the computing device 104 may manage the communication between the user device 102 and a datastore 114 for sending and receiving data therebetween. As an example, the datastore 114 may store a plurality of files, webpages, user identifiers or records, or other information. As a further example, the user device 102 may request and/or retrieve a file from the datastore 114. In an aspect, the datastore 114 may store information relating to the user device 102, such as the address element 110 and/or apparel information 112. Apparel information 112 may include identifiers of certain items of clothing (e.g., smart apparel), the number and/or types of sensing technology associated with the apparel, measured information from the sensor 118 or other information source, user data such as a location, habits, preferences, and the like. Any information may be stored in and retrieved from the datastore 114. The datastore 114 may be disposed remotely from the computing device 104 and accessed via direct or indirect connection. The datastore 114 may be integrated with the computing device 104 or some other device or system.

As described herein, various items of apparel 115 may be configured to receive or access information such as to operate as a “smart” sensing technology. As an example, the apparel 115 may include one or more of the sensors 118 for continuously or periodically measuring characteristics of the apparel 115, wearer, and/or environment of the same. Characteristics may include absolute temperature, relative temperature, humidity, air pressure, moisture, and the like. Accordingly, the sensors 118 may be or include a temperature sensor, a humidity sensor, a moisture sensor, a pressure sensor, or a combination thereof. The sensors 118 may have any size and may be powered using various energy sources such as stored energy (e.g., cell battery), kinetic energy devices, solar energy device, and the like. The sensors 118 may include cache or memory to store an amount of collected information. The sensors 118 may include a processor and/or logic to perform analytics and/or pre-processing on any information collected or received by the sensors 118. The apparel 115 may include any number and configuration of sensors 118.

The apparel 115 may include one or more thermal management elements 121. The thermal management elements 121 may be or include heating elements, cooling elements, venting elements, and the like. The thermal management elements 121 may be powered by a shared or distinct energy source. As an example, the energy source or sources may include a battery (e.g., lithium ion, zinc, solid state, liquid, etc.) such as a coin cell, and/or a kinetic, thermo-electric, solar, or other energy harvesting technology. The thermal management elements 121 may be in communication with devices to communicate therebetween. As an example, the thermal management elements 121 may communicate with the comfort manager 120 and/or the user device 102 to facilitate control of the thermal management elements 121. Each of the thermal management elements 121 may be collectively controlled or independently controlled. Each of the thermal management elements 121 may be dynamically controlled such as pulsed, ramp up, ramp down, gradient, cyclical, and the like.

The thermal management elements 121 may include cache or memory to store an amount of collected information. The thermal management elements 121 may include a processor and/or logic to perform analytics and/or processing on any information received by the thermal management elements 121 for effecting control or feedback of the thermal management elements 121. The apparel 115 may include any number and configuration of thermal management elements 121.

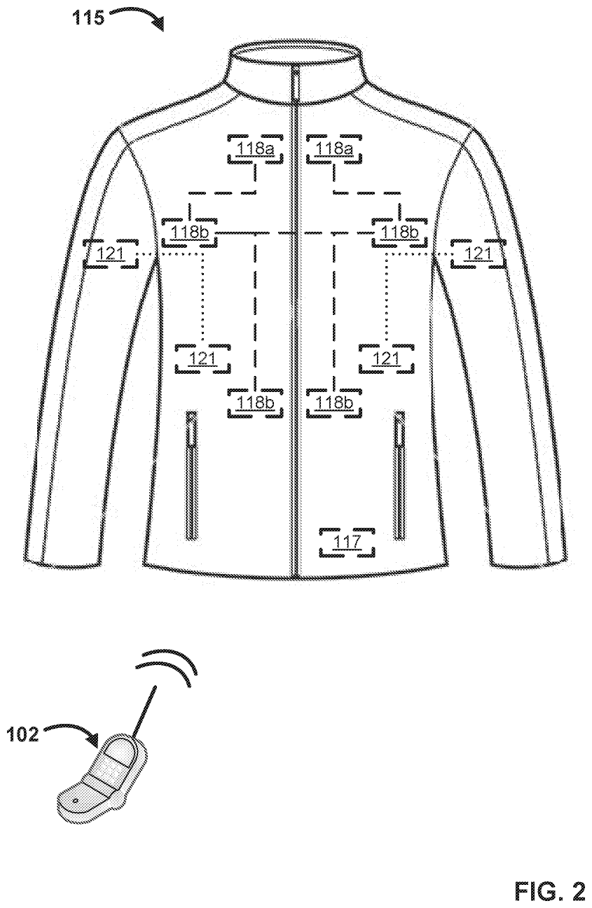

As illustrated in FIG. 2, an example item of apparel 115 may include a plurality of sensors 118a, 118b and thermal management elements 121. The sensors 118a, 118b may be in communication with each other or may be isolated from other sensors 118a, 118b. The sensors 118a, 118b may be in communication with each other via wireless or wired connection (e.g., conductive ink). The sensors 118a, 118b may be configured to send and receive information over various networks, specifications, and protocols. The sensors 118a, 118b may be disposed in any location of the item of apparel 115. As an example, outwear may include sensors 118a, 118b disposed in a chest panel, arms, and back region of the item of apparel. However, other configurations are possible. As a further example, location of the sensors 118a, 118b may be selected based on a thermal or moisture profile of a user or the item of apparel itself. The sensors 118a, 118b may be disposed to collect representative temperature and humidity data without being saturated by a high moisture environment (e.g., inside footwear). Certain sensors 118a, 118b may be configured to measure temperature using optical technology so as to minimize effect of artificial heat sources that may be disposed adjacent the apparel 115.

Certain ones of the sensors 118a may be disposed to measure characteristics external to the apparel 115. As an example, the material of the apparel 115 may include an orifice to facilitate direct measurement of external ambient environmental characteristic that are external to the apparel. Other ones of the sensors 118b may be disposed to measure characteristics internal to the apparel 115. As an example, the sensors 118 may be configured to measure characteristics of a wearer or in close proximity to a wearer's skin or under layer of clothing. Any number and configuration of sensors 118a, 118b may be used. The sensors 118a, 118b and connecting leads between the 118a, 118b may be configured to be washable to allow the apparel to be cleaned without having to detach the sensors 118a, 118b from the apparel. As discussed herein, the sensors 118a, 118b may be configured to communication with devices such as the user device 102 over various communication protocols to pass information therebetween.

Each of the thermal management elements 121 may be disposed in provide discriminate heat to particular portions of the wearer's body. As an example, thermal management elements 121 may be placed in the chest panel, along the back, and in each of the arms of a jacket. As such, the thermal management elements 121 may be controlled collectively or may be individually actuated to effect thermal management of a particular portion of the wearer's body.

The thermal management elements 121 and connecting leads between the thermal management elements 121 may be configured to be washable to allow the apparel 115 to be cleaned without having to detach the thermal management elements 121 from the apparel. As discussed herein, the thermal management elements 121 may be configured to communicate with each other, with the sensors 118a, 118b, and/or with devices such as the user device 102 over various communication protocols to pass information therebetween.

The thermal management elements 121 and the sensors 118a, 118b may be positioned to cooperatively effect thermal management. As an example, a sensor 118b may be positioned to measure temperature of an arm of the wearer. As such, one of the thermal management elements 121 may be actuated at the arm to apply discriminate thermal management to the arm of the wearer. Such a discriminate actuation of the thermal management elements 121 minimize energy use while facilitating direct thermal management to a wearer.

Returning to FIG. 1, one or more of the information sources 116 may include a datastore 119 for storing information such as information collected or received by the sensors 118. The information sources 116 may include information relating to environmental conditions such as temperature and humidity. For example, the information sources 116 may be associated with a weather service that collects location-based information about temperature and/or humidity. Such information may be stored at the datastore 119 and/or may be made available for other systems to access or receive. The information sources 116 may perform analytics such as a statistical analysis, heuristics, and/or historical trends that may be used by systems access or receiving such information.

In an aspect, a comfort manager 120 may be configured to receive information from one or more of the user device 102, the computing device 104, the sensors 118, and the information source 116. The comfort manager 120 may be or include hardware and software configured to process received information and provide feedback relating to the received information. Various configurations of hardware and software components may be used. Other components having the same or similar functionality as the comfort manager 120 may be used. The comfort manager 120 may be accessed by one or more of the user devices 102 and the computing devices 104 and by be integrated as hardware or logic into various devices and/or processing elements. The comfort manager 120 may be a standalone component, distinct from the user device 102 and/or computing device 104 or may be integrated in one or more of the user device 102, the computing device 104, or other device or system. Although not every configuration of hardware and logical components is illustrated in the drawings, it is understood that the same is contemplated by the description presented herein.

In an aspect, the comfort manager 120 may include a pre-processor component 122 configured to receive data from various sources such as one or more computing nodes (e.g., computing device 104), the user device 102, the sensors 118, and/or the information source 116. As an example, the pre-processor component 122 may be configured to receive a data dump of information and/or may be configured to process the received or accessed data to filter at least a portion of the received or accessed data. As a further example, the pre-processor component 122 may be configured to filter/classify received information based on one or more parameters such as a location, source identifier, apparel identifier 117, user profile, activity type, activity level, and the like.

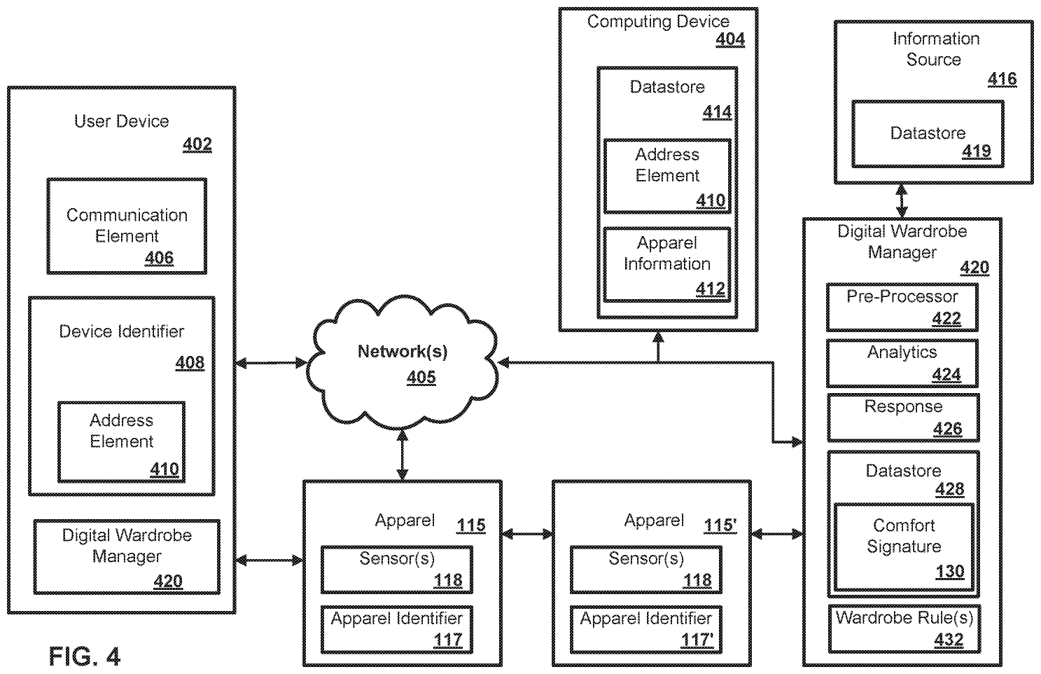

The comfort manager 120 may include an analytics component 124 configured to access or receive data (communication flows), for example, from the pre-processing component 122 or other data source. The analytics component 124 may be configured to analyze the received data, for example, using statistical analysis, comparative analysis, heuristics, and/or a machine learning algorithm to assess the current status and/or comfort signature relating to apparel and associated wearers. As an example, the analytics component 124 may be configured to execute one or more operations such as described in FIG. 4. As a further example, the analytics component 124, or one or more other components of the comfort manager 120, may be configured to generate a comfort signature 130 for one or more users/wearers based on information received by the comfort manager 120. The comfort signatures 130 may be or comprise an alphanumeric index having values associated with various levels of comfort. The comfort signature 130 may be or comprise a profile having a plurality of parameters representing a comfort of a user/wearer. The comfort signatures 130 may be stored at a datastore 128 and/or other devices or storage such as the user device 102.

The comfort manager 120 may be configured to generate one or more comfort signatures 130 based on one or more comfort rules 132. The comfort rules 132 may include logic to control the analysis of information received by the comfort manager 120. As an example, the comfort rules 132 may include look-up tables (LUTs), IF-THEN relationships, key-value pairs, weighting algorithms, machine learning, heuristics, or other mechanism to aide in the generation of the comfort signatures 130. Such rules may be stored in any location such as the datastore 128.

A response component 126 may be configured to provide assessments and recommendations based on the analysis conducted by the analytics component 124. The assessments and recommendation may include a comfort summary, updates to the predictive comfort model, apparel recommendations, and updates to user or apparel profiles. Received or accessed information, classifications, statistics, and/or remediation logs may be stored in the datastore 128. The response component 126 may be configured to autonomously update information relating to one or more items of apparel and associated users/wearers.

The response component 126 may be configured to cause actuation of one or more of the thermal management elements 121. As an example, one or more of the thermal management elements 121 may be caused to actuate in response to the comfort signature 130 reaching a particular threshold. Actuation may include generating heat, opening a vent, closing a vent, causing a heat sink, and the like. Thresholds may be established based on any conditions. As another example, select ones of the thermal management elements 121 may be caused to actuate in response to information processed by the comfort manager 120. In particular, if one of the sensors 118 located on an arm of an item of apparel 115 indicates a particular temperature or heat index, then the comfort manager 120 may cause one of the thermal management elements 121 located in the arm to actuate in order to address the sensed temperature or heat index. Other discriminate control and actuation of the thermal management elements 121 may be implemented. Each of the thermal management elements 121 may be collectively controlled or independently controlled. Each of the thermal management elements 121 may be dynamically controlled such as pulsed, ramp up, ramp down, gradient, cyclical, and the like.

The response component 126 may be configured to provide a user interface element to a wearer, for example, via the user device 102 or other device. Such a user interface element may include audio feedback, visual feedback, tactile feedback, and the like. The user interface element may indicate an instruction to the user/wearer to manipulate the apparel to change comfort. The user interface element may indicate a particular item of apparel to be worn. The user interface element may indicate a notice to the user/wearer relating to weather or other factor that may affect comfort. The user interface element may indicate a request for feedback from the user. Such a request may be representative of a feedback loop, whereby the user/wearer may agree or disagree with the comfort signature 130 applied to the wearer's current state. For example, the comfort signature 130 may indicate a high level of comfort and the wearer may indicate a “thumbs up” or agreement response that the comfort manager 120 may use to update the comfort signature 130. As another example, the comfort signature 130 may indicate a high level of comfort and the wearer may indicate a “thumbs down” or disagreement response that the comfort manager 120 may use to update the comfort signature 130. Such user feedback can be used to influence weighting factors in the comfort rules 132 and/or other analytics leveraged by the comfort manager 120.

The comfort signatures 130 may be generated based at least on information relating to a particular user/wearer. For example, a user profile or information relating to a particular user/wearer may be received or accessed by the comfort manager 120. The user profile may include information such as location, activity level, user schedule, and user preferences. Comfort signatures 130 may be generated based on one or more categories of information in the user profile. As an example, comfort signatures 130 may be generated based on various locations where the wearer is or will be located. As another example, comfort signatures 130 may be generated based on various activity levels of the wearer. As another example, comfort signatures 130 may be generated based on various points in a user's schedule. In particular, the comfort manager 120 may receive or access information relating to a user's schedule or digital calendar and may adjust the comfort signature 130 and/or responses to the user based on the current point in the user's schedule and/or expected points in the future. As another example, comfort signatures 130 may be generated based on user preferences that are user provided or learned from data relating to the user. In particular, a user may have a greater level of comfort in overcast days without precipitation as compared to windy days with light precipitation. As such, the user preference may be used to affect the comfort signature values and any feedback provided by the comfort manager 120.

As an illustrative example, the comfort manager 120 may receive or access information from the sensors 118 (directly or indirectly). Such information may include measurements of characteristics such as temperature and humidity, sensor identifiers, sensor location (globally and/or locally on the apparel), sensor measurement time and/or location stamp, apparel identifier 117, user/wearer profile information, and the like.

For example, a particular wearer may be identified to the comfort manager, for example using a unique identifier, which may be a user generated credential or other identifier such as a unique IP address, MAC address of the user device 102, a system generated identifier, an apparel identifier 117 registered to a particular user/wearer, or the like. The unique identifier of the wearer may be used to differentiate information relating to one wearer from information relating to another wearer. The information received by the comfort manager 120 may be associated with one or more sources such as a wearer or information source 116. Identifiers may be used to distinguish the sources of information for processing of the information by the comfort manager 120.

The comfort manager 120 may be configured to monitor each of the sensors 118, individually and comparatively or collectively. Changes in measured characteristics may be tracked over time. Changes may be tracked and compared between sensors 118 associated with the same apparel 115 or sensors 118 associated with different apparel 115. Information from multiple sensors 118 may be aggregated and processed to provide statistical normalization, averages, standard deviation, and the like.

The comfort manager 120 may be configured to compare measurements between external and internal sensors, such as the sensors 118a, 118b illustrated in FIG. 2. For example, a difference between measurements of the external sensors 118a and internal sensors 118b may indicate the wearer is experiencing a temperature or humidity that is different from ambient environmental characteristic. As another example, a difference between measurements of multiple external sensors 118a may indicate an outlier such as a hot spot or saturated region. Such outliers may be statistically weighted or ignored. As a further example, a difference between measurements of multiple internal sensors 118b may indicate an outlier such as a hot spot or saturated region. Such internal measurement outliers may indicate a trouble region for a particular user and may be relied upon in providing a particular recommendation for the user.

The comfort manager 120 may be configured to generate a heat index for each of one or more of the sensors 118 based at least on a temperature and humidity measurement. Heat index may also be calculated based on wind, dew point, and other measured or received characteristics. Heat index may be calculated based on the following formula:

HI=c₁+c₂T+c₃R+c₄TR+c₅T²+c₆R²+c₇T²R+c₈TR²+c₉T²R²

where

HI=heat index (in degrees Fahrenheit)

T=temperature (in degrees Fahrenheit)

R=relative humidity (percentage value between 0 and 100)

c=constants based on one or more constant tables

In certain aspects, a heat index is calculated for each of the sensors 118 associated with the item of apparel 115. Similarly, information received from the comfort manager 120 relating to other clothing or sensors may also be processed to generate a heat index. As such, the comfort manager 120 may be configured to compare heat index calculations between external and internal sensors, such as the sensors 118a, 118b illustrated in FIG. 2. For example, a difference between heat index calculations of the external sensors 118a and internal sensors 118b may indicate the wearer is experiencing a temperature or humidity that is different from ambient environmental characteristic. As another example, a difference between heat index calculations of multiple external sensors 118a may indicate an outlier such as a hot spot or saturated region. Such outliers may be statistically weighted or ignored. As a further example, a difference between heat index calculations of multiple internal sensors 118b may indicate an outlier such as a hot spot or saturated region. Such internal heat index calculation outliers may indicate a trouble region for a particular user and may be relied upon in providing a particular recommendation for the user.

The comfort manager 120 may be configured to generate the comfort signature 130 for one or more users/wearers based at least on the measured characteristics and/or calculated heat indices for one or more items of apparel 115. The comfort signature 130 may include information representing a user/wearers perceived comfort level or predicted comfort level. The comfort signatures 130 may be or comprise an alphanumeric index having values associated with various levels of comfort. The comfort signature 130 may be or comprise a profile having a plurality of parameters representing a comfort of a user/wearer. The comfort signatures 130 may be stored at a datastore 128 and/or other devices or storage such as the user device 102.

The perception of comfort may be subjective and such a representation of comfort may be a dynamic approximation over a period of time that may be updated periodically or continuously based on new information being received by the comfort manager 120.

The comfort signature 130 may be generated based on one or more comfort rules 132. As an example, the comfort rules 132 may represent that a pre-defined delta between one or more calculated heat indices indicates a particular comfort level. As the delta between heat indices goes up or down, the applied comfort rule 132 may cause the comfort signature 130 to change. The comfort rules 132 may factor in location of the wearer, activity level, a user profile, apparel-specific information, and the like. Various weighting factors may be used to reflect the various parameters considered by the confront manager 120 in applying the comfort rules 132.

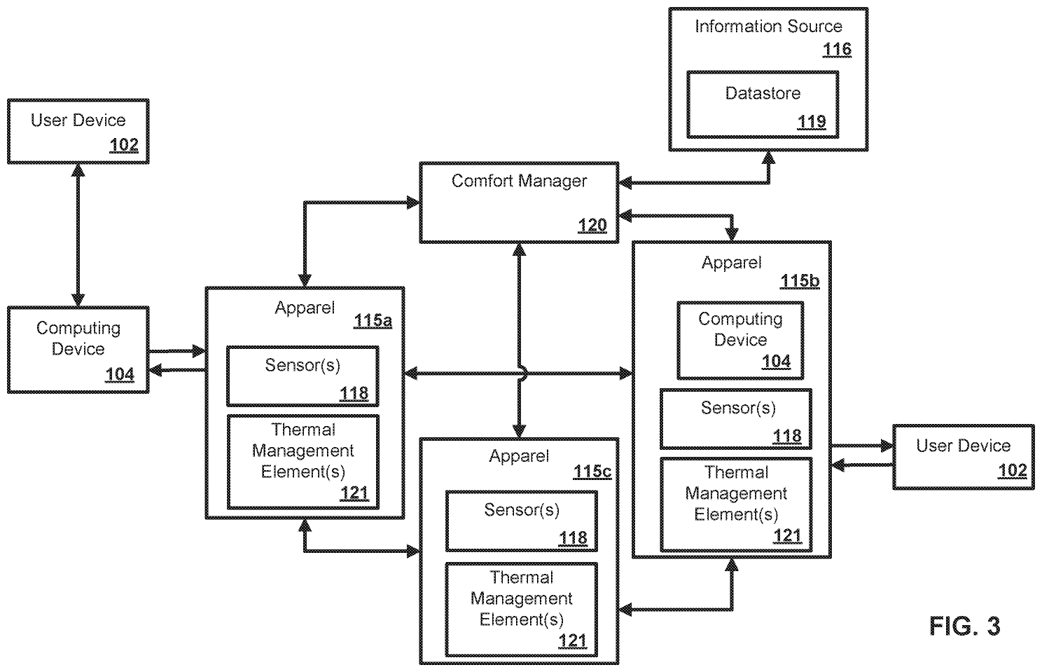

The application of comfort rules 132 and resultant comfort signatures 130 may be localized to a single item of apparel 115, or wearer, or region including one or more items of apparel 115 and wearers. The application of comfort rules 132 and resultant comfort signatures 130 may be “globalized” to represent a plurality of items of apparel 115 and wearers such as an aggregate over a larger region having one or more sub regions, as illustrated in FIG. 3, and described in further detail below.

One or more of the thermal management elements 121 may be controlled based on a result of one or more comfort rules 132. As an example, a comfort rule 132 may be configured to cause actuation of one or more of the thermal management elements 121 based upon certain prescribed conditions. As another example, the comfort rule 132 may relate to conditions such as thresholds of the comfort signature 130, heat index, temperature, moisture, humidity, and the like. As a further example, digitally controlled vents may be actuated in footwear when a particular heat index or moisture is detected using one or more comfort rules 132. Other items of apparel 115 and other thermal management elements 121 may be managed using one or more of the comfort rules 132.

FIG. 3 illustrates an exemplary system and network. In an aspect, plurality of items of apparel 115a, 115b, 115c may be in communication with one or more user devices 102 and/or one or more computing devices 104. In certain aspects, one or more of the user device 102 and the computing device 104 may be disposed in, adjacent, or in spaced proximity to one or more of items of apparel 115a, 115b, 115c. As shown in FIG. 2, the user device 120, computing device 104, information source 116, and/or comfort manager 120 may be configured to monitor and manage resources such as the apparel 115a, 115b, 115c and associated sensors 118.

In an aspect, one or more of the items of apparel 115a, 115b, 115c may be configured to communicate with at least one of the other items of apparel 115a, 115b, 115c and/or one or more of the user device 102 and computing devices 104 via one or more communication paths 206. One or more of the items of apparel 115a, 115b, 115c may include one or more of the sensors 118 configured to measure characteristics associated with the items of apparel 115a, 115b, 115c and/or the wearers of the same.

In certain aspects, the comfort manager 120 may access or receive information from various sources such as the items of apparel 115a, 115b, 115c, the computing devices 104, the user devices 102, and/or the information sources 116. The comfort manager 120 may be disposed remotely or may be in configured in one or more of the user device 120 and computing device 104. The items of apparel 115a, 115b, 115c may be located in proximity to each other or may be located remotely from each other.

As an illustrative example, the items of apparel 115a, 115b may be located within a pre-defined region such as a geo-fenced area, a city, a state, a country, or the like. Continuing the example, the item of apparel 115c may be located external to the pre-defined region of items of apparel 115a, 115b. As information is received from the sensors 118 in each other items of apparel 115a, 115b, 115c, such location information may be provided to the comfort manager 120. As the comfort manager processes the received information, specific information relating to the location of the items of apparel 115a, 115b, 115c may be used in processing the information by the comfort manager 120. Weather conditions and predictions for a region may be received from an information source 116. If such weather predictions indicate a potential change to the comfort level of users/wearers in a given region, and therefore the generated comfort signature, the comfort manager 120 may transmit warnings or indicators to wearers/users that have been identified as being located in the affected regions.

The collective information received from various items of apparel 115a, 115b may be leveraged to control the actuation of one or more the thermal management elements 121. As an example, regional information relating to factors that may affect a wearer's comfort may be gleaned from monitoring items of apparel 115a, 115b within the region. As another example, a particular region may be experiencing unpredicted precipitation. As such, if a particular wearer indicates that particular region as a destination, the comfort manager 120 may suggest a particular modification to an item of apparel 115. Similarly, if the wearer has already entered the particular region, the comfort manager 120 may actuate one or more of the thermal management elements 121 to address the precipitation condition.

As another illustrative example, the items of apparel 115a, 115b may be located within a pre-defined region such as a geo-fenced area, a city, a state, a country, or the like. Information received from the items of apparel 115a, 115b may be compared to each other. The information received relating to the items of apparel 115a, 115b may indicate certain real-time environmental characteristic measurements specific to the sensors 118 associated with each of the items of apparel 115a, 115b. As such, an external measurement associated with the item of apparel 115a may be compared to an external measurement associated with item of apparel 115b to determine an average measured characteristics. Additionally, or alternatively, information from information source 116 for the given region may also be compared to the information received from the items of apparel 115a, 115b to build a statistical model of the measured characteristics. Such a statistical model may be used to provide suggestions of apparel to one or more wearers via a digital wardrobe, as illustrated in FIG. 4.

FIG. 4 illustrates various aspects of an exemplary network in which the present methods and systems may operate. Those skilled in the art will appreciate that present methods may be used in various types of networks and systems that employ both digital and analog equipment. The system is described as comprised of elements. An element may be software, hardware, or a combination of software and hardware. One skilled in the art will appreciate that provided herein is a functional description and that the respective functions may be performed by software, hardware, or a combination of software and hardware.

In particular, FIG. 4 illustrates an example system and network for managing a plurality of items of apparel. The items of apparel may include smart apparel 115 having apparel identifiers 117 and/or conventional apparel 115′ without associated electronics. The apparel identifiers 117 may be digital identifiers that may be automatically detected via sensing device such as RFID, Bluetooth, Zigbee, IP, or some of the signaling or communication specification or protocol. The apparel identifiers 117 may be alphanumeric and/or may include descriptive information relating to the apparel 115 such as apparel type, apparel age, source of apparel, channel of distribution, location, and the like. The descriptive information and other information may be stored as an apparel profile 113. Apparel identifiers 117 may be manually generated by creating the apparel profile 113 including the apparel identifier. As such, the apparel profile 113 may be populated with information and stored with an association to the apparel identifier 117. Similarly, conventional apparel 117′ may be associated with an apparel identifier 117′ that may be manually created. For example, a user may catalogue one or more items of apparel 115, 115′ by creating apparel profiles 113 for each item of apparel and associating an apparel identifier 117, 117′ with each of the one or more items of apparel 115, 115′.

The apparel profiles 113 may include any number and types of fields. For example, the apparel profiles 113 may include information relating to scenarios when a wearer may want to wear the associated item of apparel 115, 115′. Information may include a temperature range, precipitation condition (e.g., amount and/or type), wind condition, activity type, activity level, clothing layers, age of apparel, lifecycle of apparel, and the like.

Each of the apparel profiles 113 may be stored locally and/or remotely and may be processed by a digital wardrobe manager 420 to provide a response to a user/wearer. To facilitate communication with the digital wardrobe manager 420, the systems and methods of the present disclosure may include a user device 402 (e.g., user device 102 (FIG. 1), physical computer host, virtual machine, IP-capable device) in communication with a computing device 404 (e.g., computing device 104 (FIG. 1)) such as a server or Network Interface Device (NID), for example. The computing device 404 may be disposed locally, or remotely, relative to the user device 402. As an example, the user device 402 and the computing device 404 may be in communication via a private and/or public network 405 such as the Internet. Other forms of communications may be used such as wired and wireless telecommunication channels, for example.

The user device 402 may be an electronic device such as a computer, a mobile device, a smartphone, a laptop, a tablet, a display device, or other device capable of communicating with the computing device 404. The user device 402 may be configured to communicate information relating to one or more items of clothing (apparel) and/or wearers of the same. The user device 402 may be configured to determine and communicate information relating to another device such as a sensor 418 disposed in or adjacent the apparel.

For example, the user device 402 may be or comprise a mobile computing device such as a smart phone, handheld device, or tablet. The user device 402 may be operatively coupled to one or more networks such as an IP network, a cellular network, near-field network, Bluetooth, ZigBee, or other network specification or protocol. The user device 402 may communicate with the sensor 418 to send and receive signals. In certain aspects, the user device 402 is configured to receive information from the sensor relating to one or more measured characteristics such as environmental characteristics. Such environmental characteristics may include temperature, humidity, pressure, and the like. The user device 402 may be configured to communicate with other devices such as the computing device 404. The user device 402 may receive information from the sensor 418 and may transmit the information to the computing device 404.

The user device 402 may include a communication element 406 for providing an interface to a user to interact with the user device 402 and/or the computing device 404. The communication element 406 may be any interface for presenting information to the user and receiving user feedback, such as a web browser (e.g., Internet Explorer, Mozilla Firefox, Google Chrome, Safari, or the like) or proprietary software, for example. Other software, hardware, and/or interfaces may be used to provide communication between the user and one or more of the user device 402 and the computing device 404. As an example, the communication element 406 may request or query various files from a local source and/or a remote source. As a further example, the communication element 406 may transmit data to a local or remote device such as the computing device 404.

The communication element 406 may include a display configured to facilitate interaction with a user/wearer. The communication element 406 may render a user interface including a list of the apparel 115, 115′ associated with a particular user/wearer. The list of apparel 115, 115′ may include one or more items of apparel 115, 115′ that have been manually or automatically generated. As an example, the apparel identifiers 117, 117′ may be rendered as part of the list or other identifiers may be used to distinguish one item from another. Information relating to each of the items of apparel 115, 115′ may be presented to the user. As an example, aspects of apparel profiles 113 may be displayed to a user. As a further example, a select one of the items of apparel 115, 115′ may be displayed or designated from the list of apparel 115, 115′. The select one of the items of apparel 115, 115′ may represent a suggestion of the digital wardrobe manager 420 as to the recommend item of apparel for wearing by the user. The select one of the items of apparel 115, 115′ may include reference to one or more items of apparel 115, 115′ and may further include a suggestion for layering or paring the items to effect a desired outcome or performance.

The communication element 406 may receive various inputs from the user. For example, the user may input a selection or designation of the item(s) of apparel 115, 115′ that they are wearing or plan to wear. The user may input information relating to a particular event or activity such as a location, activity type, activity level, and/or length of activity. Although reference is made to a user input, it is understood that inputs may be received from various sources and via various devices. As an examples, calendar or schedule information associated with a particular user may be accessed or received by the digital wardrobe manager 420. Such information may be leveraged to select an appropriate item of apparel 115, 115′ for a given event or time period based at least on the calendar or schedule information.

The user device 402 may be associated with a user identifier or device identifier 408. As an example, the device identifier 408 may be any identifier, token, character, string, or the like, for differentiating one user or user device (e.g., user device 402) from another user or user device. In a further aspect, the device identifier 408 may identify a user or user device as belonging to a particular class of users or user devices. As a further example, the device identifier 408 may include information relating to the user device, such as a manufacturer, a model or type of device, a service provider associated with the user device 402, a state of the user device 402, a locator, and/or a label or classifier. Other information may be represented by the device identifier 408. The device identifier 408 may be used for authentication of a user/user device to manage access to particular services or information.

The device identifier 408 may include an address element 410 such as an internet protocol address, a network address, an Internet address, or the like. As an example, the address element 410 may be relied upon to establish a communication session between the user device 402 and the computing device 404 or other devices and/or networks. As a further example, the address element 410 may be used as an identifier or locator of the user device 402.

The computing device 404 may be a server for communicating with the user device 402, other computing devices 404, and/or physical or logical components including, for example, sensors (e.g., sensor 418). As an example, the computing device 404 may communicate with the user device 402 for providing services such as peer-to-peer communication and comfort management services. In an aspect, the computing device 404 may allow the user device 402 to interact with remote resources, such as data, devices, files, and computing elements associated with one or more users or items of apparel 115. As an example, the computing device may be configured as computing module for a particular item of apparel 115. As such, the user device 402 may interact with the computing device 404 to control functions relating to the apparel 115.

The computing device 404 may manage the communication between the user device 402 and a datastore 414 for sending and receiving data therebetween. As an example, the datastore 414 may store a plurality of files, webpages, user identifiers or records, or other information. As a further example, the user device 402 may request and/or retrieve a file from the datastore 414. In an aspect, the datastore 414 may store information relating to the user device 402, such as the address element 410 and/or apparel information 412. Apparel information 412 may include identifiers of certain items of clothing (e.g., smart apparel), the number and/or types of sensing technology associated with the apparel, measured information from the sensor 418 or other information source, user data such as a location, habits, preferences, and the like. Any information may be stored in and retrieved from the datastore 414. The datastore 414 may be disposed remotely from the computing device 404 and accessed via direct or indirect connection. The datastore 414 may be integrated with the computing device 404 or some other device or system.

As described herein, various items of apparel 115 may be configured to receive or access information such as to operate as a “smart” sensing technology. As an example, the apparel 115 may include one or more of the sensors 118 for continuously or periodically measuring characteristics of the apparel 115, wearer, and/or environment of the same. Characteristics may include absolute temperature, relative temperature, humidity, air pressure, moisture, and the like. Accordingly, the sensors 118 may be or include a temperature sensor, a humidity sensor, a moisture sensor, a pressure sensor, or a combination thereof. The sensors 118 may have any size and may be powered using various energy sources such as stored energy (e.g., cell battery), kinetic energy devices, solar energy device, and the like. The sensors 118 may include cache or memory to store an amount of collected information. The sensors 118 may include a processor and/or logic to perform analytics and/or pre-processing on any information collected or received by the sensors 118. The apparel 115 may include any number and configuration of sensors 118. Conventional apparel 115′ may be apparel without the sensors 118.

One or more of the information sources 416 may include a datastore 419 for storing information such as information collected or received by the sensors 418. The information sources 416 may include information relating to environmental conditions such as temperature and humidity. For example, the information sources 416 may be associated with a weather service that collects location-based information about temperature and/or humidity. Such information may be stored at the datastore 419 and/or may be made available for other systems to access or receive. The information sources 416 may perform analytics such as a statistical analysis, heuristics, and/or historical trends that may be used by systems access or receiving such information.

The digital wardrobe manager 420 may be configured to receive information from one or more of the user device 402, the computing device 404, the sensors 118, and the information source 416. The digital wardrobe manager 420 may be or include hardware and software configured to process received information and provide feedback relating to the received information. Various configurations of hardware and software components may be used. Other components having the same or similar functionality as the digital wardrobe manager 420 may be used. The digital wardrobe manager 420 may be accessed by one or more of the user devices 402 and the computing devices 404 and by be integrated as hardware or logic into various devices and/or processing elements. The digital wardrobe manager 420 may be a standalone component, distinct from the user device 402 and/or computing device 404 or may be integrated in one or more of the user device 402, the computing device 404, or other device or system. Although not every configuration of hardware and logical components is illustrated in the drawings, it is understood that the same is contemplated by the description presented herein.

The digital wardrobe manager 420 may include a pre-processor component 422 configured to receive data from various sources such as one or more computing nodes (e.g., computing device 404), the user device 402, the sensors 418, and/or the information source 416. As an example, the pre-processor component 422 may be configured to receive a data dump of information and/or may be configured to process the received or accessed data to filter at least a portion of the received or accessed data. As a further example, the pre-processor component 422 may be configured to filter/classify received information based on one or more parameters such as a location, source identifier, apparel identifier 117, 117′, user profile, activity type, activity level, and the like.

The digital wardrobe manager 420 may include an analytics component 424 configured to access or receive data (communication flows), for example, from the pre-processing component 422 or other data source. The analytics component 424 may be configured to analyze the received data, for example, using statistical analysis, comparative analysis, heuristics, and/or a machine learning algorithm to assess the current status and/or comfort signature relating to apparel and associated wearers. As an example, the analytics component 424 may be configured to execute one or more operations such as described in FIG. 4. As a further example, the analytics component 424, or one or more other components of the digital wardrobe manager 420, may be configured to generate and/or process a comfort signature 130 for one or more users/wearers based on information received by the digital wardrobe manager 420. The comfort signatures 130 may be or comprise an alphanumeric index having values associated with various levels of comfort. The comfort signature 130 may be or comprise a profile having a plurality of parameters representing a comfort of a user/wearer. The comfort signatures 130 may be stored at a datastore 428 and/or other devices or storage such as the user device 402.

The analytics component 424 or other component of the digital wardrobe manager 420 or other device may be configured to receive or access wardrobe information associated with one or more items of apparel 115, 115′ available for a user to wear. Wardrobe information may include one or more apparel identifiers 117, 117′ and/or one or more apparel profiles 113.

The analytics component 424 or other component of the digital wardrobe manager 420 or other device may be configured to determine an environmental characteristic relating to an environment where the user intends to wear one or more items of apparel 115, 115′. Such determination may be or comprise receiving or accessing the environmental characteristic from the information source 416 or other device such as the user device 402.

The analytics component 424 or other component of the digital wardrobe manager 420 or other device may be configured to determine an activity level relating to wearing one or more items of apparel 115, 115′. Such determination may be or comprise receiving or accessing activity information from the user device 402 or other device. Such activity information may be based on historical activity relating to one or more wearers. The activity information may be based on a table of information associating various activities with activity levels. Activity levels may be defined as discrete classes such as a low level, medium level, and high level. Other classes or categories may be pre-defined to designate the activity levels.

The analytics component 424 or other component of the digital wardrobe manager 420 or other device may be configured to determine a select item of apparel 115, 115′ from the one or more items of apparel 115, 115′ based on one or more of the environmental characteristic, the activity level, and the comfort signature 130. As an example, the digital wardrobe manager 420 may analyze the environmental characteristic and the activity level (and/or the comfort signature) and may determine a best match for the given information. As a further example, the digital wardrobe manager 420 may be configured to determine (e.g., select) the select item of apparel 115, 115′ based on one or more comfort rules 432. The comfort rules 432 may include logic to control the analysis of information received by the digital wardrobe manager 420. As an example, the comfort rules 432 may include look-up tables (LUTs), IF-THEN relationships, key-value pairs, weighting algorithms, machine learning, heuristics, or other mechanism to aide in the determination of the select item of apparel 115, 115′. Such rules may be stored in any location such as the datastore 428.

A response component 426 may be configured to provide assessments and recommendations based on the analysis conducted by the analytics component 424. The assessments and recommendation may include a comfort summary, updates to the predictive comfort model, apparel recommendations, and updates to user or apparel profiles. Received or accessed information, classifications, statistics, and/or remediation logs may be stored in the datastore 428. The response component 426 may be configured to autonomously update information relating to one or more items of apparel and associated users/wearers.

The response component 426 may be configured to provide a user interface element to a wearer, for example, via the user device 402 or other device. Such a user interface element may include audio feedback, visual feedback, tactile feedback, and the like. The user interface element may indicate an instruction to the user/wearer to manipulate the apparel to change comfort. The user interface element may indicate a particular item of apparel 115, 115′ to be worn.

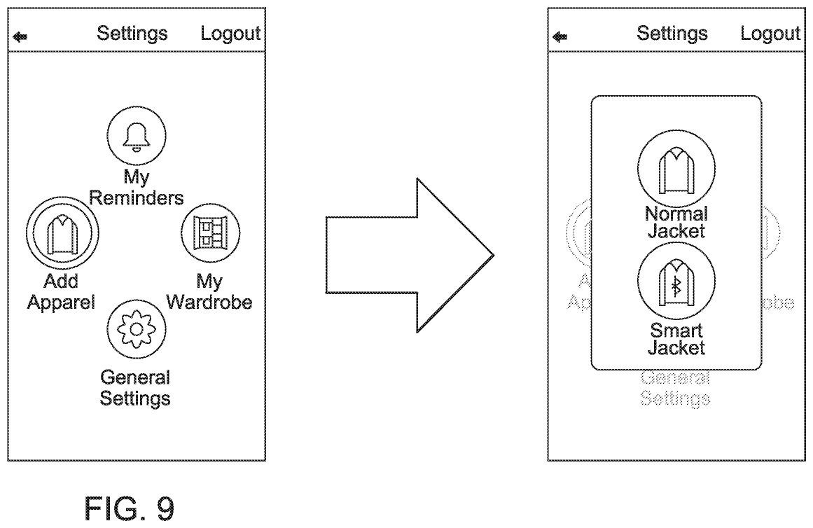

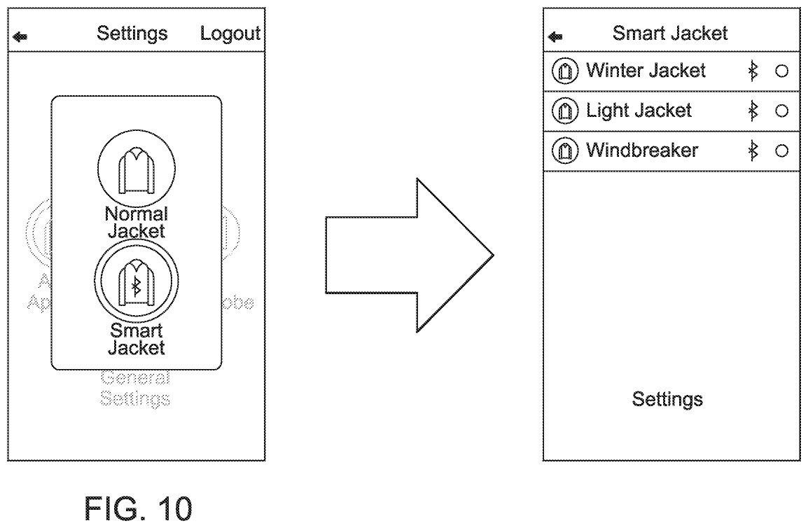

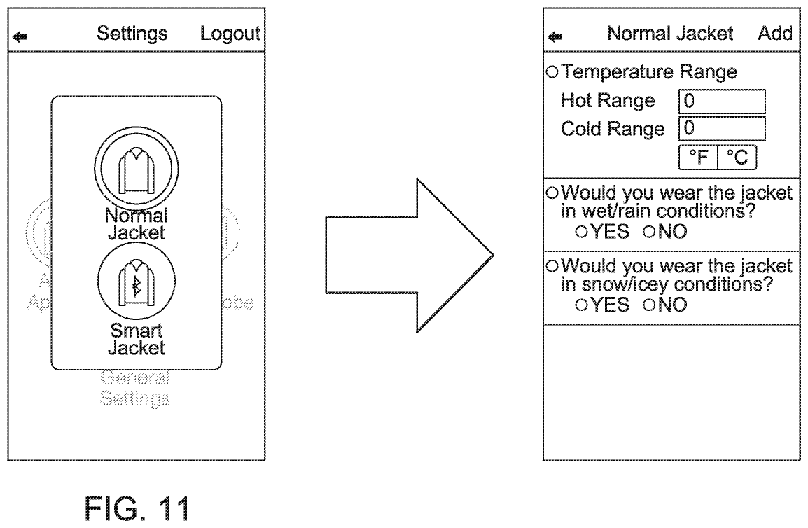

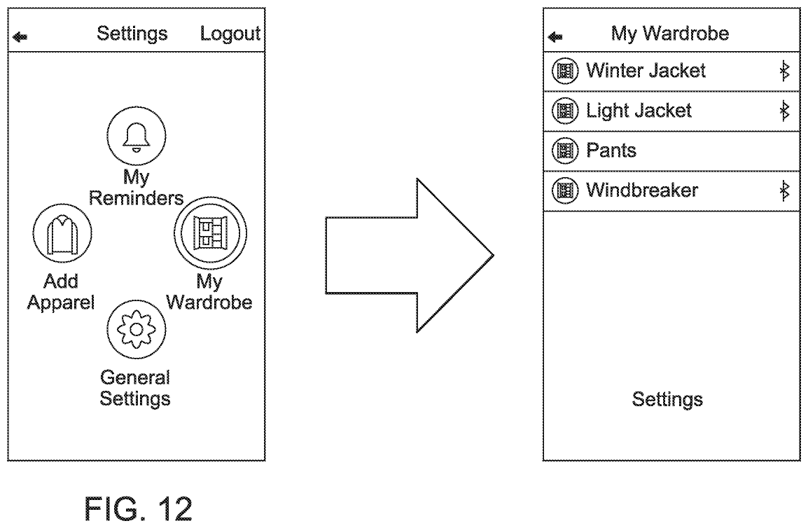

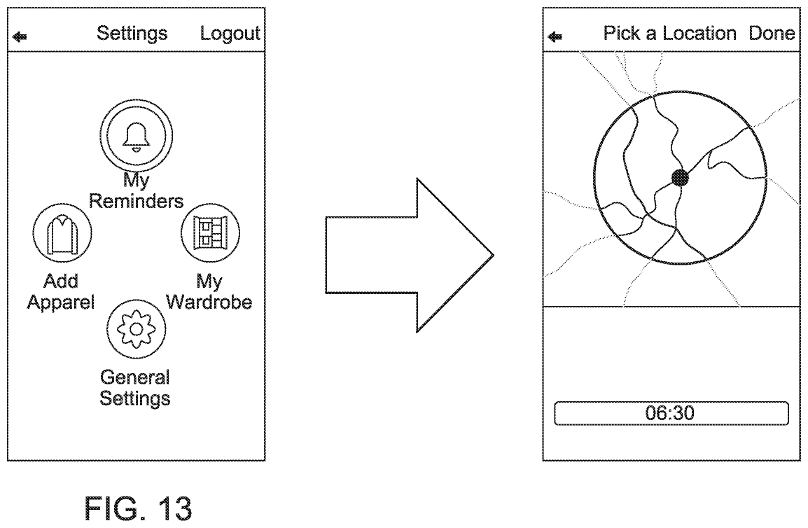

As an illustrative example, FIGS. 9-13 illustrate screen shots of example user interfaces in accordance with aspects of the present disclosure. FIG. 9 shows selectable icons that facilitate the input of one or more items of apparel 115. For example, a user may select “add item” and the user may enter an apparel profile 113 for a conventional or smart item of apparel 115. FIG. 10 shows an example interface that facilitates the automatic detection of a smart item of apparel 115 including communication technologies. As such, information that may be used to generate or load an apparel profile 113 may be automatically detected. FIG. 11 shows an example interface that facilitates the manually entry of information relating to a convention item of clothing or a smart item of apparel 115 that is not detectable automatically. FIG. 12 shows an example interface that facilitates the selection on one or more items of apparel 115 from a digital wardrobe associated with a user. FIG. 13 shows an example interface that facilitates the configuration of notifications such as calendar reminders or location-based reminders for suggesting one or more items of apparel 115.

Gesture sensing and control may allow a wearer (or another individual) to control an aspect of the smart apparel with a gesture, such as sliding a hand/finger across a conductive pad to adjust the temperature at a particular region of the apparel. Gesture sensing and control may be standardized (e.g. determined by the module or an application such as from a library of pre-determined, stored, and/or learned gesture-based commands) or may be wearer controlled (e.g. a wearer may define gesture rules representing how a module/element responds to a particular sensed gesture). For example, gesture sensing may be used to actuate one or more thermal management elements or sensors.

A datastore of recognizable gestures may include, for example, gestures from the manufacturer or an after-market developer. A sensor may include a conductive button or trigger point on a garment (such as a shirt), which may be programmed to effect command, such as activating a functionality of a user device (e.g., answering a phone, initiating/pausing playback of content, controlling volume), controlling a heat/cool level of a thermal device associated with the apparel, controlling a digital zipper, sending a message, and the like. Such a conductive trigger point may take the place of a specific hard mounted button or switch or may be integrated with any portion of the apparel such as by deposition of conductive ink.

One or more gesture sensors may be or include a conductive trace. The conductive trace may include an electrically conductively media (electrically conductive ink), an additive, or a material embedded in, on, or around a textile fibers within an intelligent apparel, a fiber optic such as via one or more of a core, dye, nano configuration, resin, spray, thread, or via such other manufacturing and/or deposition application such as embossing, heat transfer, pressing, screen printing, sublimation, weaving, or a combination thereof. The conductive traces may be interconnected with each other or may be independent. The conductive traces may be in electrical communication with a circuit or drive to apply voltage to the conductive trace and/or to sense an electrical interaction with the conductive trace, such as a shift in capacitance.

One or more of the sensors 118 may include a gesture sensor configured to detect a position and or movement of a gesture indicator such as a wearer's hand, for example. In certain aspects, the gesture sensors may include a conductive ink disposed on one or more layers of the apparel 115. As an example, one or more of the sensors 118 (e.g., gesture sensors) may be or comprise a conductive ink that is screen printed directly onto the material (e.g., fabric) of the apparel. The conductive ink may include resins or adhesives blended with powdered conductive materials such as, gold, silver, copper, graphite powder, carbon black, nickel or other metals or alloys. They may also be carbon-based ink, silver-based ink, or a combination of carbon-based and silver-based inks. The conductive ink may be coated on the apparel 115 using any of a variety of methods known in the art, including but not limited to, screen printing, applying by brush, applying by roller, spraying, dipping, masking, vacuum plating, vacuum deposition or any combination of the foregoing. The sensors 118 may include any deposition pattern, size and shape.

In certain aspects, a capacitance profile of one or more sensors 118 may be interpreted as a particular sensed gesture. The capacitance of at least the gesture-type sensors 118, for example, may be measured by a variety of electrical methods. It is understood that the RC time constant characteristic of sensors 118 may change in response to a shift in capacitance of the respective sensor 118. As an example, a voltage shift or phase shift in the frequency response may be used to sense a particular interaction with the respective sensors 118. Other methods may be used. As a further example, a profile of the sensed shift may be associated with a particular gesture such that a detection of the same or similar (e.g., within tolerance or some pre-defined error).

Other mechanisms for sensing and control may be used.

### Methods

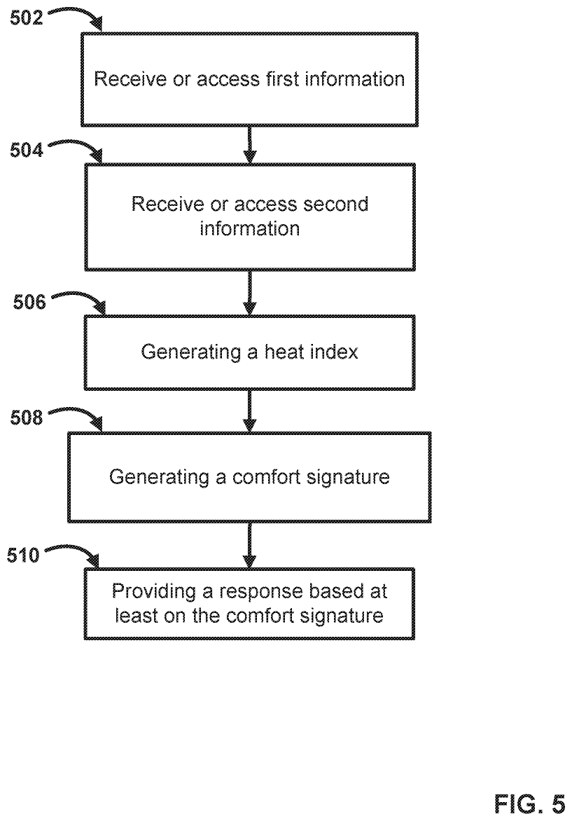

FIG. 5 depicts example operating procedures that may be implemented by the systems and networks described hereon. For example, in reference to FIGS. 1-4, operation or step 502 may include receiving or accessing first information. The first information may be or include first environmental characteristic information such as temperature, humidity, pressure, wind, and the like. The first information may be received, directly or indirectly, from one or more sensors 118 associated with one or more items of apparel 115. The first information may be raw data representing measurements or may be processed data. Additionally or alternatively, the first information may include a user identifier, apparel identifier 117, location, or time stamp, or combination thereof.

In operation or step 504, second information may be received or accessed. The second information may be or include second environmental characteristic information such as temperature, humidity, pressure, wind, and the like. The second information may be received, directly or indirectly, from one or more sensors 118 associated with one or more items of apparel 115. The second information may be raw data representing measurements or may be processed data. Additionally or alternatively, the second information may include a user identifier, apparel identifier 117, location, or time stamp, or combination thereof.

The second information may be associated with the same or different source as the first information. For example, the first information and second information may be received, directly or indirectly, from a first sensor 118, but at different times. As another example, the first information and second information may each be received, directly or indirectly, from different sensors 118 associated with the same item of apparel 115. As a further example, the first information and second information may each be received, directly or indirectly, from different sensors 118 associated with different items of apparel 115.

In operation or step 506, a heat index may be generated based at least on the first information or the second information, or a combination thereof. The heat index may be calculated periodically or continuously for each of one or more sensors 118 associated with one or more items of apparel 115.

In operation or step 508, a comfort signature may be generated based at least on one or more of the first information, the second information, and the generated heat indices. The comfort signature 130 may include information representing a user/wearers perceived comfort level or predicted comfort level. The comfort signatures 130 may be or comprise an alphanumeric index having values associated with various levels of comfort. The comfort signature 130 may be or comprise a profile having a plurality of parameters representing a comfort of a user/wearer. The comfort signatures 130 may be stored at a datastore 128 and/or other devices or storage such as the user device 102.

The perception of comfort may be subjective and such a representation of comfort may be a dynamic approximation over a period of time that may be updated periodically or continuously based on new information being received by the comfort manager 120.

The comfort signature 130 may be generated based on one or more comfort rules 132. As an example, the comfort rules 132 may represent that a pre-defined delta between one or more calculated heat indices indicates a particular comfort level. As the delta between heat indices goes up or down, the applied comfort rule 132 may cause the comfort signature 130 to change. The comfort rules 132 may factor in location of the wearer, activity level, a user profile, apparel-specific information, and the like. Various weighting factors may be used to reflect the various parameters considered by the confront manager 120 in applying the comfort rules 132.

The application of comfort rules 132 and resultant comfort signatures 130 may be localized to a single item of apparel 115, or wearer, or region including one or more items of apparel 115 and wearers. The application of comfort rules 132 and resultant comfort signatures 130 may be “globalized” to represent a plurality of items of apparel 115 and wearers such as an aggregate over a larger region having one or more sub regions

In operation or step 510, a response may be provided to a user based at least on the comfort signature 130. The response may include assessments and recommendations based on the analysis relating to the apparel 115 and a wearer of the apparel 115. The assessments and recommendation may include a comfort summary, updates to the predictive comfort model, apparel recommendations, and updates to user or apparel profiles.

The response may including a user interface element provided to a wearer, for example, via the user device 102 or other device. Such a user interface element may include audio feedback, visual feedback, tactile feedback, and the like. The user interface element may indicate an instruction to the user/wearer to manipulate the apparel to change comfort. The user interface element may indicate a particular item of apparel to be worn. The user interface element may indicate a notice to the user/wearer relating to weather or other factor that may affect comfort. The user interface element may indicate a request for feedback from the user. Such a request may be representative of a feedback loop, whereby the user/wearer may agree or disagree with the comfort signature 130 applied to the wearer's current state. For example, the comfort signature 130 may indicate a high level of comfort and the wearer may indicate a “thumbs up” or agreement response that the comfort manager 120 may use to update the comfort signature 130. As another example, the comfort signature 130 may indicate a high level of comfort and the wearer may indicate a “thumbs down” or disagreement response that the comfort manager 120 may use to update the comfort signature 130. Such user feedback can be used to influence weighting factors in the comfort rules 132 and/or other analytics leveraged by the comfort manager 120.

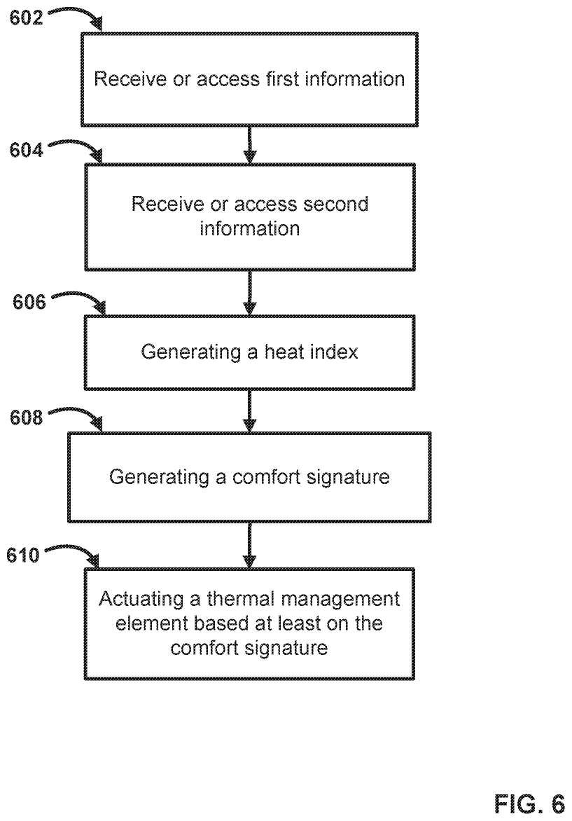

FIG. 6 depicts example operating procedures that may be implemented by the systems and networks described hereon. For example, in reference to FIGS. 1-4, operation or step 602 may include receiving or accessing first information. The first information may be or include first environmental characteristic information such as temperature, humidity, pressure, wind, and the like. The first information may be received, directly or indirectly, from one or more sensors 118 associated with one or more items of apparel 115. The first information may be raw data representing measurements or may be processed data. Additionally or alternatively, the first information may include a user identifier, apparel identifier 117, location, or time stamp, or combination thereof.

In operation or step 604, second information may be received or accessed. The second information may be or include second environmental characteristic information such as temperature, humidity, pressure, wind, and the like. The second information may be received, directly or indirectly, from one or more sensors 118 associated with one or more items of apparel 115. The second information may be raw data representing measurements or may be processed data. Additionally or alternatively, the second information may include a user identifier, apparel identifier 117, location, or time stamp, or combination thereof.

The second information may be associated with the same or different source as the first information. For example, the first information and second information may be received, directly or indirectly, from a first sensor 118, but at different times. As another example, the first information and second information may each be received, directly or indirectly, from different sensors 118 associated with the same item of apparel 115. As a further example, the first information and second information may each be received, directly or indirectly, from different sensors 118 associated with different items of apparel 115.

In operation or step 606, a heat index may be generated based at least on the first information or the second information, or a combination thereof. The heat index may be calculated periodically or continuously for each of one or more sensors 118 associated with one or more items of apparel 115.

In operation or step 608, a comfort signature may be generated based at least on one or more of the first information, the second information, and the generated heat indices. The comfort signature 130 may include information representing a user/wearers perceived comfort level or predicted comfort level. The comfort signatures 130 may be or comprise an alphanumeric index having values associated with various levels of comfort. The comfort signature 130 may be or comprise a profile having a plurality of parameters representing a comfort of a user/wearer. The comfort signatures 130 may be stored at a datastore 128 and/or other devices or storage such as the user device 102.

The perception of comfort may be subjective and such a representation of comfort may be a dynamic approximation over a period of time that may be updated periodically or continuously based on new information being received by the comfort manager 120.

The comfort signature 130 may be generated based on one or more comfort rules 132. As an example, the comfort rules 132 may represent that a pre-defined delta between one or more calculated heat indices indicates a particular comfort level. As the delta between heat indices goes up or down, the applied comfort rule 132 may cause the comfort signature 130 to change. The comfort rules 132 may factor in location of the wearer, activity level, a user profile, apparel-specific information, and the like. Various weighting factors may be used to reflect the various parameters considered by the confront manager 120 in applying the comfort rules 132.

The application of comfort rules 132 and resultant comfort signatures 130 may be localized to a single item of apparel 115, or wearer, or region including one or more items of apparel 115 and wearers. The application of comfort rules 132 and resultant comfort signatures 130 may be “globalized” to represent a plurality of items of apparel 115 and wearers such as an aggregate over a larger region having one or more sub regions

In operation or step 610, a response may be provided to a user based at least on the comfort signature 130. The response may include assessments and recommendations based on the analysis relating to the apparel 115 and a wearer of the apparel 115. The assessments and recommendation may include a comfort summary, updates to the predictive comfort model, apparel recommendations, and updates to user or apparel profiles.

In certain aspects, the response comprises actuation of one or more of the thermal management elements 121. As an example, one or more of the thermal management elements 121 may be caused to actuate in response to the comfort signature 130 reaching a particular threshold. Actuation may include generating heat, opening a vent, closing a vent, causing a heat sink, and the like. Thresholds may be established based on any conditions. As another example, select ones of the thermal management elements 121 may be caused to actuate in response to information processed by the comfort manager 120. In particular, if one of the sensors 118 located on an arm of an item of apparel 115 indicates a particular temperature or heat index, then the comfort manager 120 may cause one of the thermal management elements 121 located in the arm to actuate in order to address the sensed temperature or heat index. Other discriminate control and actuation of the thermal management elements 121 may be implemented. Each of the thermal management elements 121 may be collectively controlled or independently controlled. Each of the thermal management elements 121 may be dynamically controlled such as pulsed, ramp up, ramp down, gradient, cyclical, and the like.

The response may including a user interface element provided to a wearer, for example, via the user device 102 or other device. Such a user interface element may include audio feedback, visual feedback, tactile feedback, and the like. The user interface element may indicate an instruction to the user/wearer to manipulate the apparel to change comfort. The user interface element may indicate a particular item of apparel to be worn. The user interface element may indicate a notice to the user/wearer relating to weather or other factor that may affect comfort. The user interface element may indicate a request for feedback from the user. Such a request may be representative of a feedback loop, whereby the user/wearer may agree or disagree with the comfort signature 130 applied to the wearer's current state. For example, the comfort signature 130 may indicate a high level of comfort and the wearer may indicate a “thumbs up” or agreement response that the comfort manager 120 may use to update the comfort signature 130. As another example, the comfort signature 130 may indicate a high level of comfort and the wearer may indicate a “thumbs down” or disagreement response that the comfort manager 120 may use to update the comfort signature 130. Such user feedback can be used to influence weighting factors in the comfort rules 132 and/or other analytics leveraged by the comfort manager 120.

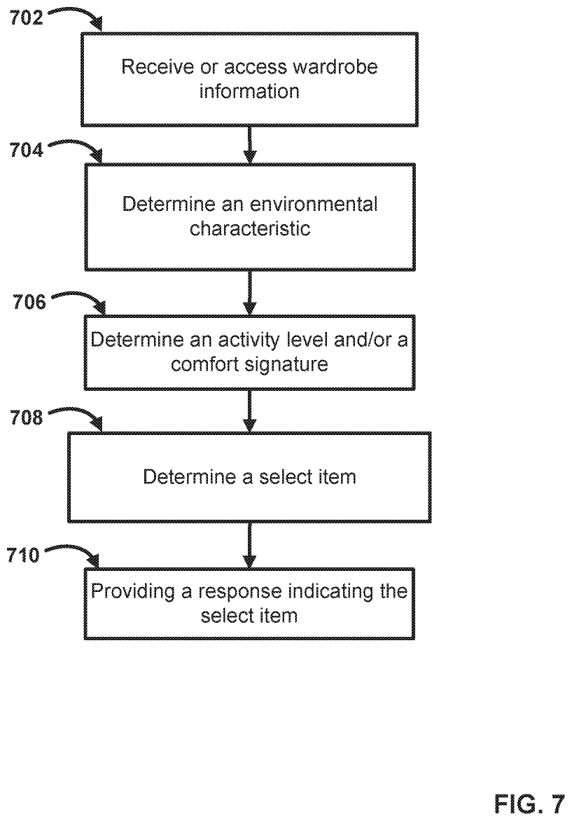

FIG. 7 depicts example operating procedures that may be implemented by the systems and networks described hereon. For example, in reference to FIGS. 1-4, operation or step 702, wardrobe information may be accessed or received. The wardrobe information may be associated with one or more items of clothing available for a user to wear. The wardrobe information may comprises an apparel profile. The apparel profile may include: a temperature range, precipitation condition, wind condition, activity type, activity level, clothing layers, age of apparel, lifecycle of apparel, and the like.

In operation or step 704, an environmental characteristic may be determined. The environmental characteristic may relate to an environment where the user intends to wear the one or more items of clothing. The environmental characteristic may include one or more of a temperature, humidity, pressure, wind speed, and precipitation. Determining the environmental characteristic may include accessing or receiving the environmental characteristic from one or more of an information source and a user device.

In operation or step 706, an activity level and/or comfort signature may be determined. The activity level may relate to wearing the one or more items of clothing. The comfort signature may be associated with the user/wearer. The activity level may include one of a predetermined category of activity level.

In operation or step 708, a select item of the clothing may be determined from the one or more items of clothing based at least on the environmental characteristic, the activity level, and/or the comfort signature. Determining the select item may be based on a comfort signature associated with the user.

In operation or step 710, a response to the user may be provided. The response may indicate the select item of clothing from the one or more items of clothing. Providing a response may include an indication of a plurality of select items of clothing from the one or more items of clothing to be worn in a prescriber manner.

Those of skill will appreciate that the various illustrative logical blocks, modules, and algorithm steps described in connection with the aspects disclosed herein may be implemented as electronic hardware, computer software, or combinations of both. To clearly illustrate this interchangeability of hardware and software, various illustrative components, blocks, modules, and steps have been described above generally in terms of their functionality.

Whether such functionality is implemented as hardware or software depends upon the design constraints imposed on the overall system. Skilled persons may implement the described functionality in varying ways for each particular application, but such implementation decisions should not be interpreted as causing a departure from the scope of the invention. In addition, the grouping of functions within a module, block, or step is for ease of description. Specific functions or steps may be moved from one module or block without departing from the invention.

The various illustrative logical blocks and modules described in connection with the aspects disclosed herein may be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor (e.g., of a computer), or in a combination of the two. A software module may reside, for example, in RAM memory, flash memory, ROM memory, EPROM memory, EEPROM memory, registers, hard disk, a removable disk, a CD-ROM, or any other form of storage medium. An exemplary storage medium may be coupled to the processor such that the processor may read information from, and write information to, the storage medium. In the alternative, the storage medium may be integral to the processor. The processor and the storage medium may reside in an ASIC.

In at least some aspects, a processing system (e.g., electronic control system 200) that implements a portion or all of one or more of the technologies described herein may include a general-purpose computer system that includes or is configured to access one or more computer-accessible media.

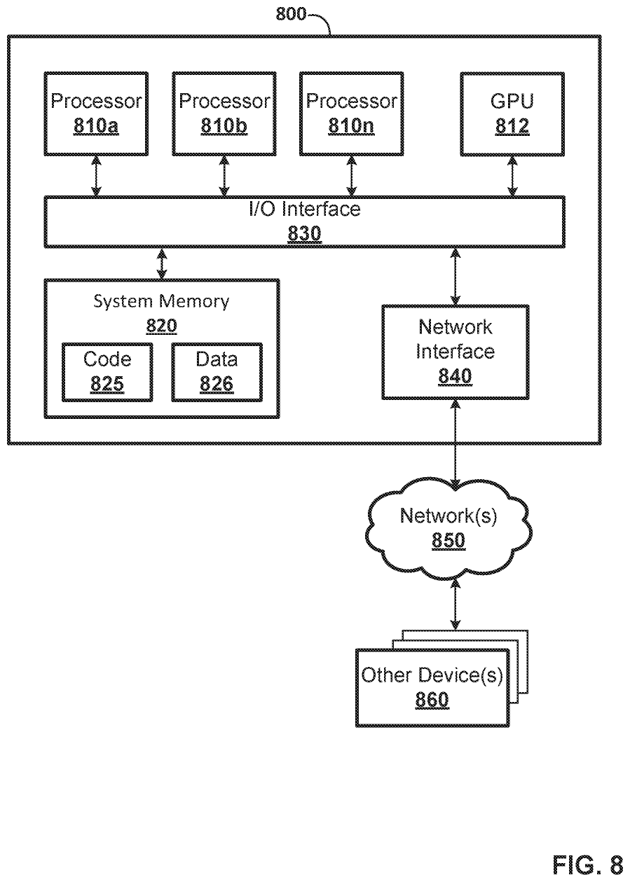

FIG. 8 depicts a general-purpose computer system that includes or is configured to access one or more computer-accessible media. In the illustrated aspect, computing device 500 includes one or more processors 810a, 810b, and/or 810n (which may be referred herein singularly as a processor 810 or in the plural as the processors 810) coupled to a system memory 820 via an input/output (I/O) interface 830. Computing device 800 further includes a network interface 840 coupled to I/O interface 830.

In various aspects, computing device 800 may be a uniprocessor system including one processor 810 or a multiprocessor system including several processors 810 (e.g., two, four, eight, or another suitable number). Processors 810 may be any suitable processors capable of executing instructions. For example, in various aspects, processor(s) 810 may be general-purpose or embedded processors implementing any of a variety of instruction set architectures (ISAs), such as the x86, PowerPC, SPARC, or MIPS ISAs, or any other suitable ISA. In multiprocessor systems, each of processors 810 may commonly, but not necessarily, implement the same ISA.

In some aspects, a graphics processing unit (“GPU”) 812 may participate in providing graphics rendering and/or physics processing capabilities. A GPU may, for example, include a highly parallelized processor architecture specialized for graphical computations. In some aspects, processors 810 and GPU 812 may be implemented as one or more of the same type of device.

System memory 820 may be configured to store instructions and data accessible by processor(s) 810. In various aspects, system memory 820 may be implemented using any suitable memory technology, such as static random access memory (“SRAM”), synchronous dynamic RAM (“SDRAM”), nonvolatile/Flash®-type memory, or any other type of memory. In the illustrated aspect, program instructions and data implementing one or more desired functions, such as those methods, techniques and data described above, are shown stored within system memory 820 as code 825 and data 826.

In one aspect, I/O interface 830 may be configured to coordinate I/O traffic between processor(s) 810, system memory 820 and any peripherals in the device, including network interface 840 or other peripheral interfaces. In some aspects, I/O interface 830 may perform any necessary protocol, timing or other data transformations to convert data signals from one component (e.g., system memory 820) into a format suitable for use by another component (e.g., processor 810). In some aspects, I/O interface 830 may include support for devices attached through various types of peripheral buses, such as a variant of the Peripheral Component Interconnect (PCI) bus standard or the Universal Serial Bus (USB) standard, for example. In some aspects, the function of I/O interface 830 may be split into two or more separate components, such as a north bridge and a south bridge, for example. Also, in some aspects some or all of the functionality of I/O interface 830, such as an interface to system memory 820, may be incorporated directly into processor 810.

Network interface 840 may be configured to allow data to be exchanged between computing device 800 and other device or devices 860 attached to a network or networks 850, such as other computer systems or devices, for example. In various aspects, network interface 840 may support communication via any suitable wired or wireless general data networks, such as types of Ethernet networks, for example. Additionally, network interface 840 may support communication via telecommunications/telephony networks, such as analog voice networks or digital fiber communications networks, via storage area networks, such as Fibre Channel SANs (storage area networks), or via any other suitable type of network and/or protocol.

In some aspects, system memory 820 may be one aspect of a computer-accessible medium configured to store program instructions and data as described above for implementing aspects of the corresponding methods and apparatus. However, in other aspects, program instructions and/or data may be received, sent, or stored upon different types of computer-accessible media. Generally speaking, a computer-accessible medium may include non-transitory storage media or memory media, such as magnetic or optical media, e.g., disk or DVD/CD coupled to computing device 800 via I/O interface 830. A non-transitory computer-accessible storage medium may also include any volatile or non-volatile media, such as RAM (e.g., SDRAM, DDR SDRAM, RDRAM, SRAM, etc.), ROM, etc., that may be included in some aspects of computing device 800 as system memory 820 or another type of memory. Further, a computer-accessible medium may include transmission media or signals, such as electrical, electromagnetic or digital signals, conveyed via a communication medium, such as a network and/or a wireless link, such as those that may be implemented via network interface 540. Portions or all of multiple computing devices, such as those illustrated in FIG. 5, may be used to implement the described functionality in various aspects; for example, software components running on a variety of different devices and servers may collaborate to provide the functionality. In some aspects, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

It should also be appreciated that the systems in the figures are merely illustrative and that other implementations might be used. Additionally, it should be appreciated that the functionality disclosed herein might be implemented in software, hardware, or a combination of software and hardware. Other implementations should be apparent to those skilled in the art. It should also be appreciated that a server, gateway, or other computing node may include any combination of hardware or software that may interact and perform the described types of functionality, including without limitation desktop or other computers, datastore servers, network storage devices and other network devices, PDAs, tablets, cellphones, wireless phones, pagers, electronic organizers, Internet appliances, television-based systems (e.g., using set top boxes and/or personal/digital video recorders), and various other consumer products that include appropriate communication capabilities. In addition, the functionality provided by the illustrated modules may in some aspects be combined in fewer modules or distributed in additional modules. Similarly, in some aspects the functionality of some of the illustrated modules may not be provided and/or other additional functionality may be available.

Each of the operations, processes, methods, and algorithms described in the preceding sections may be embodied in, and fully or partially automated by, code modules executed by at least one computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto may be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example aspects. The example systems and components described herein may be configured differently than described. For example, elements may be added to, removed from, or rearranged compared to the disclosed example aspects.

It will also be appreciated that various items are illustrated as being stored in memory or on storage while being used, and that these items or portions of thereof may be transferred between memory and other storage devices for purposes of memory management and data integrity. Alternatively, in other aspects some or all of the software modules and/or systems may execute in memory on another device and communicate with the illustrated computing systems via inter-computer communication. Furthermore, in some aspects, some or all of the systems and/or modules may be implemented or provided in other ways, such as at least partially in firmware and/or hardware, including, but not limited to, at least one application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other aspects. Accordingly, the present invention may be practiced with other computer system configurations.

### Aspects

The present disclosure comprises at least the following aspects:

Aspect 1: A method for managing a comfort of a wearer, the method comprising: determining a first environmental characteristic using a first sensor disposed adjacent an item of apparel; determining a second environmental characteristic using a second sensor disposed adjacent the item of apparel; determining a comfort signature based at least on the first environmental characteristic and the second environmental characteristic; and providing a response to a wearer of the item of apparel based at least upon the comfort signature.

Aspect 2: The method of aspect 1, wherein the first environmental characteristic comprises one or more of a temperature, humidity, pressure, wind speed, and precipitation.

Aspect 3: The method of any one of aspects 1-2, wherein the second environmental characteristic comprises one or more of a temperature, humidity, pressure, wind speed, and precipitation.

Aspect 4: The method of any one of aspects 1-3, wherein the first sensor is disposed to measure the first environmental characteristic internal to the item of apparel.

Aspect 5: The method of any one of aspects 1-4, wherein the second sensor is disposed to measure the second environmental characteristic external to the item of apparel.

Aspect 6: The method of any one of aspects 1-5, wherein determining the comfort signature comprises calculating a heat index associated with one or more of the first environmental characteristic and the second environmental characteristic.

Aspect 7: The method of any one of aspects 1-6, wherein determining the comfort signature is dependent on parameter of the wearer or item of apparel, the parameter comprising a location, activity level, apparel type, time of day, or a combination thereof.

Aspect 8: The method of any one of aspects 1-7, wherein the response to the wearer comprises one or more of audio feedback, visual feedback, and tactile feedback.

Aspect 9: The method of any one of aspects 1-8, wherein the response to the wearer indicates a notification to the wearer of the comfort signature, instructions to the wearer, a suggestion to alter the item of apparel, or a suggested item of apparel, or a combination thereof.

Aspect 10: The method of any one of aspects 1-9, further comprising receiving third environmental characteristics from an information source, wherein the comfort signature is based at least on the first environmental characteristic, the second environmental characteristic, and the third environmental characteristic.

Aspect 11: The method of aspect 10, wherein the information source is associated with a weather service.

Aspect 12: A comfort management system comprising: a memory comprising one or more comfort rules and processor executable instructions; a processor in communication with the memory, the processor configured to: receive a first environmental characteristic associated with a first sensor disposed adjacent an item of apparel; receive a second environmental characteristic associated with a second sensor disposed adjacent the item of apparel; determine a comfort signature based at least on the first environmental characteristic, the second environmental characteristic, and the one or more comfort rules; and provide a response to a wearer of the item of apparel based at least upon the comfort signature.

Aspect 13: The comfort management system of aspect 12, wherein the first environmental characteristic comprises one or more of a temperature, humidity, pressure, wind speed, and precipitation.

Aspect 14: The comfort management system of any one of aspects 12-13, wherein the second environmental characteristic comprises one or more of a temperature, humidity, pressure, wind speed, and precipitation.

Aspect 15: The comfort management system of any one of aspects 12-14, wherein the first sensor is disposed to measure the first environmental characteristic internal to the item of apparel.

Aspect 16: The comfort management system of any one of aspects 12-15, wherein the second sensor is disposed to measure the second environmental characteristic external to the item of apparel.

Aspect 17: The comfort management system of any one of aspects 12-16, wherein determining the comfort signature comprises calculating a heat index associated with one or more of the first environmental characteristic and the second environmental characteristic.

Aspect 18: The comfort management system of any one of aspects 12-17, wherein determining the comfort signature is dependent on parameter of the wearer or item of apparel, the parameter comprising a location, activity level, apparel type, time of day, or a combination thereof.

Aspect 19: The comfort management system of any one of aspects 12-18, wherein the response to the wearer comprises one or more of audio feedback, visual feedback, and tactile feedback.

Aspect 20: The comfort management system of any one of aspects 12-19, wherein the response to the wearer indicates a notification to the wearer of the comfort signature, instructions to the wearer, a suggestion to alter the item of apparel, or a suggested item of apparel, or a combination thereof.

Aspect 21: A method for managing a comfort of a wearer, the method comprising: determining a first environmental characteristic using a first sensor disposed adjacent an item of apparel; determining a second environmental characteristic using a second sensor disposed adjacent the item of apparel; determining a comfort signature based at least on the first environmental characteristic and the second environmental characteristic; and causing actuation of a thermal management element based at least on the comfort signature.

Aspect 22: The method of aspect 21, wherein the first environmental characteristic comprises one or more of a temperature, humidity, pressure, wind speed, and precipitation.

Aspect 23: The method of any one of aspects 21-22, wherein the second environmental characteristic comprises one or more of a temperature, humidity, pressure, wind speed, and precipitation.

Aspect 24: The method of any one of aspects 21-23, wherein the first sensor is disposed to measure the first environmental characteristic internal to the item of apparel.

Aspect 25: The method of any one of aspects 21-24, wherein the second sensor is disposed to measure the second environmental characteristic external to the item of apparel.

Aspect 26: The method of any one of aspects 21-25, wherein the first sensor and the second sensor are disposed in discriminate locations of the item of apparel.

Aspect 27: The method of any one of aspects 21-26, wherein determining the comfort signature comprises calculating a heat index associated with one or more of the first environmental characteristic and the second environmental characteristic.

Aspect 28: The method of any one of aspects 21-27, wherein determining the comfort signature is dependent on parameter of the wearer or item of apparel, the parameter comprising a location, activity level, apparel type, time of day, or a combination thereof.

Aspect 29: The method of any one of aspects 21-28, wherein the actuation comprises generating heat, opening a vent, closing a vent, or causing a heat sink, or a combination thereof.

Aspect 30: The method of any one of aspects 21-28, wherein the actuation comprises energizing a cooling or heating element.

Aspect 31: The method of any one of aspects 21-30, further comprising receiving third environmental characteristics from an information source, wherein the comfort signature is based at least on the first environmental characteristic, the second environmental characteristic, and the third environmental characteristic.

Aspect 32: The method of aspect 31, wherein the information source is associated with a weather service.

Aspect 33: A comfort management system comprising: a memory comprising one or more comfort rules and processor executable instructions; a processor in communication with the memory, the processor configured to: receive a first environmental characteristic associated with a first sensor disposed adjacent an item of apparel; receive a second environmental characteristic associated with a second sensor disposed adjacent the item of apparel; determine a comfort signature based at least on the first environmental characteristic, the second environmental characteristic, and the one or more comfort rules; and cause actuation of a thermal management element based at least on the comfort signature.

Aspect 34: The comfort management system of aspect 33, wherein the first environmental characteristic comprises one or more of a temperature, humidity, pressure, wind speed, and precipitation.

Aspect 35: The comfort management system of any one of aspects 33-34, wherein the second environmental characteristic comprises one or more of a temperature, humidity, pressure, wind speed, and precipitation.

Aspect 36: The comfort management system of any one of aspects 33-35, wherein the first sensor is disposed to measure the first environmental characteristic internal to the item of apparel.

Aspect 37: The comfort management system of any one of aspects 33-36, wherein the second sensor is disposed to measure the second environmental characteristic external to the item of apparel.

Aspect 38: The comfort management system of any one of aspects 33-37, wherein the first sensor and the second sensor are disposed in discriminate locations of the item of apparel.

Aspect 39: The comfort management system of any one of aspects 33-38, wherein determining the comfort signature comprises calculating a heat index associated with one or more of the first environmental characteristic and the second environmental characteristic.

Aspect 40: The comfort management system of any one of aspects 33-39, wherein determining the comfort signature is dependent on parameter of the wearer or item of apparel, the parameter comprising a location, activity level, apparel type, time of day, or a combination thereof.

Aspect 41: A method for managing a wardrobe of a wearer, the method comprising: receiving or accessing wardrobe information associated with one or more items of apparel available for a user to wear; determining an environmental characteristic relating to an environment where the user intends to wear the one or more items of apparel; determining an activity level relating to wearing the one or more items of apparel; determining a select item of the apparel from the one or more items of apparel based at least on the environmental characteristic and the activity level; and providing a response to the user indicating the select item of apparel from the one or more items of apparel.

Aspect 42: The method of aspect 41, wherein the wardrobe information comprises an apparel profile.

Aspect 43: The method of aspect 42, wherein the apparel profile comprises: a temperature range, precipitation condition, wind condition, activity type, activity level, apparel layers, age of apparel, lifecycle of apparel, and the like.

Aspect 44: The method of any one of aspects 41-43, wherein the environmental characteristic comprises one or more of a temperature, humidity, pressure, wind speed, and precipitation.

Aspect 45: The method of any one of aspects 41-44, wherein determining the environmental characteristic comprises accessing or receiving the environmental characteristic from one or more of an information source and a user device.

Aspect 46: The method of any one of aspects 41-45, wherein the activity level comprises one of a predetermined category of activity level.

Aspect 47: The method of any one of aspects 41-46, wherein determining the select item is based on a comfort signature associated with the user.

Aspect 48: The method of any one of aspects 41-47, wherein providing a response comprises an indication of a plurality of select items of apparel from the one or more items of apparel to be worn in a prescriber manner.

Aspect 49: A wardrobe management system comprising: a memory comprising one or more wardrobe rules and processor executable instructions; a processor in communication with the memory, the processor configured to: receive or access wardrobe information associated with one or more items of apparel available for a user to wear; determine an environmental characteristic relating to an environment where the user intends to wear the one or more items of apparel; determine an activity level relating to wearing the one or more items of apparel; determine a select item of the apparel from the one or more items of apparel based at least on the environmental characteristic and the activity level; and provide a response to the user indicating the select item of apparel from the one or more items of apparel.

Aspect 50: The wardrobe management system of aspect 49, wherein the wardrobe information comprises an apparel profile.

Aspect 51: The wardrobe management system of aspect 50, wherein the apparel profile comprises: a temperature range, precipitation condition, wind condition, activity type, activity level, apparel layers, age of apparel, lifecycle of apparel, and the like.

Aspect 52: The wardrobe management system of any one of aspects 49-51, wherein the environmental characteristic comprises one or more of a temperature, humidity, pressure, wind speed, and precipitation.

Aspect 53: The wardrobe management system of any one of aspects 49-52, wherein determining the environmental characteristic comprises accessing or receiving the environmental characteristic from one or more of an information source and a user device.

Aspect 54: The wardrobe management system of any one of aspects 49-53, wherein the activity level comprises one of a predetermined category of activity level.

Aspect 55: The wardrobe management system of any one of aspects 49-54, wherein determining the select item is based on a comfort signature associated with the user.

Aspect 56: The wardrobe management system of any one of aspects 49-55, wherein providing a response comprises an indication of a plurality of select items of apparel from the one or more items of apparel to be worn in a prescriber manner.

Aspect 57: A method for managing a wardrobe of a wearer, the method comprising: receiving or accessing wardrobe information associated with one or more items of apparel available for a user to wear; determining an environmental characteristic relating to an environment where the user intends to wear the one or more items of apparel; determining a comfort signature associated with the user; determining a select item of the apparel from the one or more items of apparel based at least on the environmental characteristic and the activity level; and providing a response to the user indicating the select item of apparel from the one or more items of apparel.

Aspect 58: The method of aspect 57, wherein the wardrobe information comprises an apparel profile.

Aspect 59: The method of aspect 58, wherein the apparel profile comprises: a temperature range, precipitation condition, wind condition, activity type, activity level, apparel layers, age of apparel, lifecycle of apparel, and the like.

Aspect 60: The method of any one of aspects 57-59, wherein the environmental characteristic comprises one or more of a temperature, humidity, pressure, wind speed, and precipitation.

Aspect 61: The method of any one of aspects 57-60, wherein determining the environmental characteristic comprises accessing or receiving the environmental characteristic from one or more of an information source and a user device.

Aspect 62: The method of any one of aspects 57-61, wherein providing a response comprises an indication of a plurality of select items of apparel from the one or more items of apparel to be worn in a prescriber manner.

Conditional language used herein, such as, among others, “may,” “could,” “might,” “may,” “e.g.,” and the like, unless specifically stated otherwise, or otherwise understood within the context as used, is generally intended to convey that certain aspects include, while other aspects do not include, certain features, elements, and/or steps. Thus, such conditional language is not generally intended to imply that features, elements, and/or steps are in any way required for at least one aspects or that at least one aspects necessarily include logic for deciding, with or without author input or prompting, whether these features, elements, and/or steps are included or are to be performed in any particular aspect. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example aspects have been described, these aspects have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

The preceding detailed description is merely exemplary in nature and is not intended to limit the invention or the application and uses of the invention. The described aspects are not limited to use in conjunction with a particular type of apparel. Furthermore, there is no intention to be bound by any theory presented in the preceding background or detailed description. It is also understood that the illustrations may include exaggerated dimensions to better illustrate the referenced items shown, and are not consider limiting unless expressly stated as such.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

1. A method for managing a comfort of a wearer, the method comprising:
determining a first environmental characteristic using a first sensor disposed adjacent an item of apparel;
determining a second environmental characteristic using a second sensor disposed adjacent the item of apparel;
determining a comfort signature based at least on the first environmental characteristic and the second environmental characteristic; and
providing a response to a wearer of the item of apparel based at least upon the comfort signature.

2. The method of claim 1, wherein the first environmental characteristic comprises one or more of a temperature, humidity, pressure, wind speed, and precipitation.

3. The method of claim 1, wherein the second environmental characteristic comprises one or more of a temperature, humidity, pressure, wind speed, and precipitation.

4. The method of claim 1, wherein the first sensor is disposed to measure the first environmental characteristic internal to the item of apparel.

5. The method of claim 1, wherein the second sensor is disposed to measure the second environmental characteristic external to the item of apparel.

6. The method of claim 1, wherein determining the comfort signature comprises calculating a heat index associated with one or more of the first environmental characteristic and the second environmental characteristic.

7. The method of claim 1, wherein determining the comfort signature is dependent on parameter of the wearer or item of apparel, the parameter comprising a location, activity level, apparel type, time of day, or a combination thereof.

8. The method of claim 1, wherein the response to the wearer comprises one or more of audio feedback, visual feedback, and tactile feedback.

9. The method of claim 1 wherein the response to the wearer indicates a notification to the wearer of the comfort signature, instructions to the wearer, a suggestion to alter the item of apparel, or a suggested item of apparel, or a combination thereof.

10. The method of claim 1, further comprising receiving third environmental characteristics from an information source, wherein the comfort signature is based at least on the first environmental characteristic, the second environmental characteristic, and the third environmental characteristic.

11. The method of claim 10, wherein the information source is associated with a weather service.

12. A method for managing a comfort of a wearer, the method comprising:
determining a first environmental characteristic using a first sensor disposed adjacent an item of apparel;
determining a second environmental characteristic using a second sensor disposed adjacent the item of apparel;
determining a comfort signature based at least on the first environmental characteristic and the second environmental characteristic; and
causing actuation of a thermal management element based at least on the comfort signature.

13. The method of claim 12, wherein the first environmental characteristic comprises one or more of a temperature, humidity, pressure, wind speed, and precipitation and wherein the second environmental characteristic comprises one or more of a temperature, humidity, pressure, wind speed, and precipitation.

14. The method of claim 12, wherein the first sensor is disposed to measure the first environmental characteristic internal to the item of apparel.

15. The method of claim 12, wherein the second sensor is disposed to measure the second environmental characteristic external to the item of apparel.

16. The method of claim 12, wherein the first sensor and the second sensor are disposed in discriminate locations of the item of apparel.

17. The method of claim 12, wherein determining the comfort signature comprises calculating a heat index associated with one or more of the first environmental characteristic and the second environmental characteristic and wherein determining the comfort signature is dependent on parameter of the wearer or item of apparel, the parameter comprising a location, activity level, apparel type, time of day, or a combination thereof.

18. The method of claim 12, wherein the causing actuation comprises generating heat, opening a vent, closing a vent, or causing a heat sink, or a combination thereof.

19. A method for managing a wardrobe of a wearer, the method comprising:
receiving or accessing wardrobe information associated with one or more items of apparel available for a user to wear;
determining an environmental characteristic relating to an environment where the user intends to wear the one or more items of apparel;
determining an activity level relating to wearing the one or more items of apparel;
determining a select item of the apparel from the one or more items of apparel based at least on the environmental characteristic and the activity level; and
providing a response to the user indicating the select item of apparel from the one or more items of apparel.

20. The method of claim 19, wherein the wardrobe information comprises an apparel profile and wherein the apparel profile comprises: a temperature range, precipitation condition, wind condition, activity type, activity level, apparel layers, age of apparel, lifecycle of apparel, and wherein providing a response comprises an indication of a plurality of select items of apparel from the one or more items of apparel to be worn in a prescriber manner.
